(19) United States
(12) Patent Application Publication
(10) Pub. No.: US 2021/0402292 A1
(43) Pub. Date: Dec. 30, 2021

(54) METHOD OF HAPTIC RESPONSES AND INTERACTING

(71) Applicant: Sony Interactive Entertainment LLC, San Mateo, CA (US)

(72) Inventor: Katrine Chow, San Mateo, CA (US)

(21) Appl. No.: 16/912,618

(22) Filed: Jun. 25, 2020

(51) Int. Cl. A63F 13/285; A63F 13/53; A63F 13/79; G02B 27/01; G06N 20/00

(52) U.S. Cl. CPC A63F 13/285; A63F 13/53; A63F 2300/1037; G02B 27/017; G06N 20/00; A63F 13/79

(57) ABSTRACT

Methods and systems for providing response to a player during game play of a video game includes detecting an interactive task within a game scenario of the video game that requires an action from the player. In response to detecting the interactive task, a profile of the player playing the video game, is identified. A haptic response is provided to the player in accordance to haptic setting defined for the player profile of the player. The haptic response is provided to the player via an input device used by the player for providing game input to the video game. The haptic response that is provided is specific for the player and is provided to guide the player toward the interactive task within the game scenario of the video game.

### TECHNICAL FIELD

The present disclosure relates to providing notification to a user during game play, to alert the user to a portion of game scenario, and more specifically to providing notification to the user to perform an interactive task via a controller used for providing game input during game play of a video game, wherein the notification is customized for the user.

### BACKGROUND OF THE DISCLOSURE

Interactive applications, such as video games, virtual life simulations, educational applications, music applications, etc., have gained popularity in recent years. The vast majority of the video games are streaming three dimensional (3D) video games (also called massively multiplayer online games—MMOG). The MMOG are simultaneously accessed by a large number of users by connecting over a network, such as the Internet. A user of a MMO application assumes a role of a virtual character or a game icon and controls action of the virtual characters or the game icon using inputs provided via input devices, such as keyboards, game controllers, touch screens, etc. Through the inputs, the user can navigate virtual space and interact with gaming environment and with virtual characters/game icons of other users in accordance to game rules and goals specified for the video game. The user may provide inputs in collaboration with other users (e.g., as part of a team) to achieve a shared goal or may be in competition with other users (e.g., competitively) to progress in the video game.

The video game may be played using any computing device, including a desktop computer, a laptop computer, a mobile computing device, etc., and inputs provided using an input device, such as a game controller, a keyboard, a control interface provided on a display screen, etc., associated with the computing device. One of the main objectives of the video game application is to maximize user immersion in the video game. However, due to playing style of the different users, the user immersion may be varied resulting in less than satisfactory experience for the user. For example, some users may be slow in responding to game prompts, or miss certain game prompts, or miss interacting with game assets that are shown to be beneficial to the user during game play, or require more assistance during game play, or get easily distracted or be hyper-focused in certain parts of the game and miss out on other parts of the game that may be meaningful or beneficial to the user, etc.

It is in this context that embodiments of the disclosure arise.

### SUMMARY

Embodiments of the present disclosure relate to systems and methods for providing haptic responses to a user playing a video game. In one embodiment, the haptic responses are customized for the user. For example, the play style can be examined for different types of gaming actions and contexts and based on that analysis information regarding a haptic response that is to be provided to the user are saved to a profile of the user. Over time, based on the user's gaming activities, learning algorithms may be used to update information regarding the haptic responses and how they are provided to the user. The update information is also updated to the profile of the user. Haptic responses are provided via peripheral devices, e.g., gaming controllers, to convey information to the regarding the gaming interactivity. The conveyed information can be context specific, such as based on what is occurring in the game. In some cases, the conveyed information by the haptic responses is intended to notify the user of certain behavior required of the user during the gameplay. By way of example, the haptic responses can include vibrational cues to a controller. The vibrational cues can be provided to the controller in a way that more or less vibration occurs to different parts or specific parts of the controller. If the information to be conveyed to the user is to move the controller or a game object controlled by the user to the right, the vibration can be provided more to the right handle of the controller. In some cases, the vibration provided can be configured to move or shift from one side of the controller to another. As noted above, these types of coordinated haptic responses can be customized for the user based on the play style or learned behavior. For instance, if a user needs more assistance in deciding where to move the controller or move a game object controlled by the controller or move an input button of the controller, the vibrational cues can be provided using specific components of the controller. In specific instances, the vibrational cues may be provided with more magnitude or for a longer period of time. If the user needs less assistance, the vibrational cues can be automatically adjusted downward. The specific components of the controller may include haptic elements that are incorporated within the controller and associated with each of the buttons/joysticks of the controller, and/or associated with interactive screen of the controller, and/or with the controller as a whole.

In one embodiment, game inputs provided by the user are used to adjust game state of the video game and to generate game play data. The game play data includes telemetry data that can be analyzed to determine the speed of game play, actions performed by the user, progression made in the game play in response to the actions, time taken to perform each action, etc., from which a play style and other game play features of the user can be determined. In addition to the game style and game play features, the system may also identify an interactive task within a game scenario of the video game that the user missed interacting with or that requires an action from the user. The interactive task that the user missed or requires action may be identified by correlating content of the game scenario with context of actions performed by the user in the game scenario. Responsive to detecting the interactive task in the game scenario requiring user interaction, the system provides haptic response to the user to make the user aware of the presence of the interactive task in the game scenario and where required, guide the user to perform action that is directed toward accomplishing goal of the interactive task. The haptic response provided to the user is customized for the user. In one implementation, the system learns the game style of the user and dynamically generates haptic settings that can be used when providing the haptic response. In alternate implementation, the haptic response may be customized in accordance to input provided by the user to define the haptic setting, wherein the input provided by the user fits their feedback requirements. In another implementation, initial customization to the haptic setting may be done by the system and additional customization may be done using input from the user. The haptic response provides the user with sufficient cues to detect the interactive task and to interact with the interactive task in the game scenario.

In one implementation, a method is disclosed for providing a haptic response to a user during game play of the video game. The method includes detecting an interactive task within a game scenario of the video game that requires an action from the user. The interactive task is identified by correlating content of the game scenario with context of actions performed by the user in the game scenario. A user profile of the user playing the video game, is identified. A haptic response is generated to the user in accordance to haptic setting defined for the user profile of the user. The haptic response is provided to the user via a controller used for providing game input to the video game. The haptic response that is provided is specific for the user and is provided to guide the user toward the interactive task within the game scenario of the video game.

In one implementation, the haptic response continues till the action from the user is detected at the interactive task.

In one implementation, the haptic response includes deactivating controls of the controller so as to prevent the user from progressing in the video game till the action from the user is detected at the interactive task.

In one implementation, the haptic response is generated using features of the controller.

In one implementation, the haptic response includes a spatial cue for directing the user to the interactive task in the game scenario, wherein the spatial cue is provided using a three-dimensional representation of the game scenario of the video game.

In one implementation, the haptic response is triggered in accordance to haptic settings that are customized for the user.

In one implementation, the haptic settings are pre-defined by user.

In one implementation, the haptic settings are dynamically defined based on a play style of the user. The play style is determined using a haptic learning engine that uses machine learning logic. The haptic learning engine is dynamically trained with game inputs of the user and game progression made by the user in the video game. The haptic settings are dynamically adjusted from the training and applied to the controller when the haptic response is triggered. The dynamic adjustments to the haptic settings are updated to the user profile of the user.

In one implementation, the game progression is determined using telemetry data collected from the game play of the video game of the user. The telemetry data is analyzed to extract specific features that are indicative of the play style of the user or the game progression of the video game.

In one implementation, the action required from the user is a movement in a particular direction, and the haptic response provided during game play includes a directional cue to indicate a direction the user has moved or has to move in relation to the interactive task.

In one implementation, the controller has a plurality of haptic elements, and the directional cue provided in the haptic response includes activating the plurality of elements sequentially so as to allow the haptic response to flow from one haptic element to a subsequent haptic element of the plurality of haptic elements in the direction specified in the directional cue.

In one implementation, the haptic response is defined to provide variation in a feedback provided to the user. The variation in the feedback is dynamically controlled to indicate different actions performed by the user in the video game and is intuitive to the user.

In one implementation, the haptic response is configured to vary with time, based on content of the game scenario of the video game or game input provided by the user.

In one implementation, the haptic response for the user is generated to correlate with content of the game scenario and context of actions performed by the user in the game scenario.

In one implementation, the interactive task is to interact with a game asset or an avatar of another user playing the video game.

In another implementation, a method is disclosed for providing a haptic response to a user during game play of a video game. The method includes identifying an interactive task within a game scenario of the video game that requires an action from the user. The interactive task is identified by correlating content of the game scenario with context of actions performed by the user in the game scenario. A user profile of the user playing the video game is identified. A haptic response for providing to the user is generated in accordance to haptic settings defined for the user profile of the user. The haptic response is specific for the user and is used to guide the user toward the interactive task in the game scenario of the video game.

In some implementations, the haptic response is provided to the user via a game controller used for providing game input to the video game.

In some implementations, the haptic response is provided to the user via a head mounted display used for viewing game play of the video game.

In another implementation, a method for providing haptic response to a user during game play of a video game, is disclosed. The method includes examining gaming actions performed by the user during game play of the video game. The examining includes examining context of the gaming actions in relation to content of a game scenario occurring in the video game. Information related to the haptic response that is to be provided to the user, is identified based on the examination of the gaming actions. The information is used to define haptic settings that is specific for the user. The defined haptic settings are stored in a user profile of the user. The information related to the haptic response is dynamically updated based on gaming actions of the user collected during game play. The updating of the information causes a corresponding update to the haptic settings defined in the user profile of the user. The haptic response is generated to the user in response to detecting an interactive task within the game scenario of the video game that requires an action from the user. The interactive task is identified by correlating content of the game scenario with context of the gaming actions performed by the user in the game scenario. The haptic response is generated in accordance to the haptic settings defined in the user profile of the user and is generated to guide the user toward the interactive task within the game scenario of the video game.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings.

FIG. 1 illustrates a simplified conceptual game cloud site for collecting game inputs of a user that is used to determine haptic setting that needs to be used to provide notification, in accordance with one implementation of the disclosure.

FIG. 2 illustrates a simplified block diagram of a controller haptics profiler used to define haptic setting used to provide haptic response to a user during game play, in accordance with one implementation of the present disclosure.

FIG. 3 illustrates a simplified block diagram of different modules within the controller haptics profiler used to generate haptic response for a user during game play of the video game, in accordance with one implementation of the present disclosure.

FIG. 4 illustrates a simplified block diagram of different modules within a haptic response customization engine used to generated customized haptic setting for the haptic response provided to the user during game play of the video game, in accordance with one implementation of the present disclosure.

FIG. 5A illustrates a view of game scenario of a video game that the user is currently playing, in accordance with one implementation of the present disclosure.

FIGS. 5B-5D illustrate simplified perspective views of haptic response provided to the user using a game controller, in accordance with one implementation of the present disclosure.

FIG. 6 illustrates a flow diagram of various operations of a method used in generating haptic response to a user during game play of a video game, in accordance with one implementation of the present disclosure.

FIG. 7 illustrates an example implementation of an Information Service Provider architecture, in accordance with one implementation of the present disclosure.

FIG. 8 illustrates a simplified block diagram of a game cloud server used for defining haptic setting used for providing haptic response to the user via a controller, in accordance with one implementation of the present disclosure.

### DETAILED DESCRIPTION

In the following description, numerous specific details are set forth in order to provide a thorough understanding of the present disclosure. It will be apparent, however, to one skilled in the art that the present disclosure may be practiced without some or all of these specific details. In other instances, well known process steps have not been described in detail in order not to obscure the present disclosure.

Currently, players play a video game (simply referred to as “game”) by selecting the video game title from a game cloud server and providing game inputs using input devices, such as controllers, keyboards, mouse, touch screen, etc., associated with a computing device, such as a mobile device, laptop device, etc. The video game may be a streaming video game that receives the game inputs and generates frames of game content that is streamed to the client device of the player for rendering. The video game executing on the game cloud server is capable of live streaming the game play over a network, such as the Internet. The video game may be a single user game or a massive multiplayer online game played by a plurality of players accessing the video game from one geolocation or from multiple geolocations.

The game inputs provided by a player are used to influence a game state of the video game and to generate game play data. The game inputs of the player correspond to the activities performed by the player in the video game, wherein the activities affect the game state of the video game. The game inputs of the player and activities performed in the video game are part of telemetry data that provide information related to game play of the player, from which the game style, game progression, game competency, skill level, etc., of the player can be easily deduced. The telemetry data captures characteristics of each game scenario of the video game, characteristics of each activity performed by the player, attributes of the player, etc., that can be processed to determine overall game state of the game. Characteristics of game scenario may include details of game assets (e.g., static objects, moving objects, etc.) defined in the game scenario, wherein the game assets include task graphical objects, game characters, visual tasks, game objects, different locations in the game scenario, path to one or more game assets, area where the game asset is located, a bush, a tree, a front yard, back yard, street, buildings, another game region, another player, a game move, static objects, moving objects, non-player characters, player avatars, avatars representing spectators, interactive tasks that require user interaction, task interactive tasks that do not include user interaction, etc. An interactive task may include performing an action on one or more game assets. Some examples of actions that can be performed on the game asset may include moving an object, shooting an object, shooting at a visual task, following a certain path, changing the path a game object is moving, interacting with another player, building a game object, cutting a tree, walking down a street, throwing a ball, etc. The game scenario may represent a location where there is a game object or game asset, background objects and/or foreground objects that are part of the game scenario, etc., and appear in one or more frames of streaming game content, textual or graphic content that is present or is occurring currently, tasks that need to be performed, rendition of results of action(s) performed on a game object, etc. The characteristics of each activity captured in the telemetry data include details related to type of activities that a player attempted, activities the player accomplished, activities the player failed to accomplish, activities the player failed to attempt, game assets tasked by each activity, etc. These characteristics are captured using the context of the game scenarios the player accessed during game play of the video game and the actions/game inputs provided by the player. The attributes of the player that can be determined from the telemetry data, include play style (e.g., conservative player, risk taker, innovative moves, response speed, focus level (e.g., too involved or very distracted, etc.), type of player (e.g., novice, expert, etc.), etc. The player attributes may be updated to a player profile of the player. The game state of the video game identifies overall state of the video game at a particular point and is influenced by intricacies of the game play of the player. The game play data is processed by game logic of the video game to generate frames of content that is forwarded to a client device of the player for rendering. If the video game is a MMO game, then game inputs from a plurality of players are used to influence the overall game state of the video game. The telemetry data is also used to identify saved data of the player, wherein the saved data includes any game customization provided by the player for the video game.

Generally, most of the players who play the video game are able to cope with the speed of game play of the video game and have reaction times that correspond with the speed of game play of the video game. However, there may be certain players whose reaction times may not be as sharp as the rest of the players. The slow reaction times may be due to these players getting easily distracted or not able to focus on the game play or due to slow responses. As a result, these players may miss certain interactive tasks (e.g., interacting with one or more visual cues) task that are present in the game scenario of the game. The interactive tasks that they may miss may be needed by the player as these interactive tasks may assist the player in accumulating certain game points or rewards or tools, etc., that may be needed to progress in the video game. For example, the player may fail to observe or pay attention or interact with a treasure chest that is present in a corner or at an extreme side of the game scenario. The treasure chest may have a key to unlock a game level or have a game tool that may be needed by the player for subsequent game play. Missing out on such visual cues would result in the player not be able to make much progress in the game.

To address such issues, various implementations of the present disclosures describe systems and methods for creating a sensible interface to provide haptic responses to a player playing a video game. The haptic response is used to notify the player of presence of such interactive tasks within a game scenario of the video game. The interactive tasks may identify a game object or game asset that the player can interact with in the game scenario. The haptic responses are provided to the player through the interface is in addition to regular game prompts provided by the game logic. The haptic responses are customized in accordance to the player's play style and are provided to the player through one or more input devices used to provide game inputs to the video game. The customization may be based on inputs received from the player, or from another player, or from a user associated with the player. For example, the player's play style can be examined for different types of gaming actions and contexts. Based on the information collected from analysis of the player's play style, appropriate haptic responses to be provided to the player are identified and saved in a profile of the player. The analysis of the play style and identification of the appropriate haptic responses are performed by learning algorithms in association with game logic. As the player's play style refines over time, the learning algorithm detects the refinement and updates the profile of the player. The haptic responses are provided to the player via peripheral devices (e.g., gaming controllers or simply referred to hereonwards as “controllers”) to nudge or guide the player to the interactive task. The notification of the interactive tasks may be provided through features available within the peripheral devices.

In some implementations, the input devices through which the notification is provided to the player may be a game controller that was used by the player to provide game inputs. The features of the game controller are used to provide the notification. For example, the buttons, the touch screen, the haptic elements, etc., of the controller may be used to provide the notification. In some implementations, the notification may provide directional cue to guide the player toward the interactive task.

The haptic responses convey information to the player regarding the game interactive tasks. The conveyed information can be context specific (e.g., based on what is occurring in the video game), or temporal specific (e.g., specific time of day or expiration of pre-defined period of time), or player specific, or any combinations thereof. In some cases, the haptic responses convey information to notify the player of certain behavior required of the player during gameplay.

The haptic responses, for example, may be provided as vibrational cues to the controller. The vibrational cues may be provided to the controller, such that more or less vibration occurs at different parts or at specific parts of the controller. For example, if the information to be conveyed to the player is to move the controller or direct the players attention or move a game object controlled by the player to the right, the vibrational cues is provided to cause the right handle of the controller to vibrate. In some cases, the vibrational cues can be configured to cause vibration provided at the controller to move or shift from one side of the controller to another. These types of coordinated haptic responses can be customized for the player based on the play style or learned behavior of the player. For instance, if the player needs more assistance in deciding which button to press, or which direction to move the game object or which direction to turn or which direction to direct the player's attention on the screen, the vibrational cues can be provided using specific components of the controller. In some specific instances, the vibration may be provided with more magnitude or for a longer period of time. If the learning algorithm learns that the player is more comfortable playing the game and does not need additional assistance, the vibrational cues may be automatically adjusted downward. The specific components of the controller that can be used for providing the haptic responses may include haptic elements that are incorporated within the controller. The haptic elements may be individual elements associated with different buttons/controls/joysticks of the controller, or an array of elements associated with the interactive screen of the controller. In addition to vibrational cues, the haptic responses may be provided as audio cues, textual cues, visual cues, etc.

With the general understanding of the inventive embodiments, example details of the various implementations will now be described with reference to the various drawings.

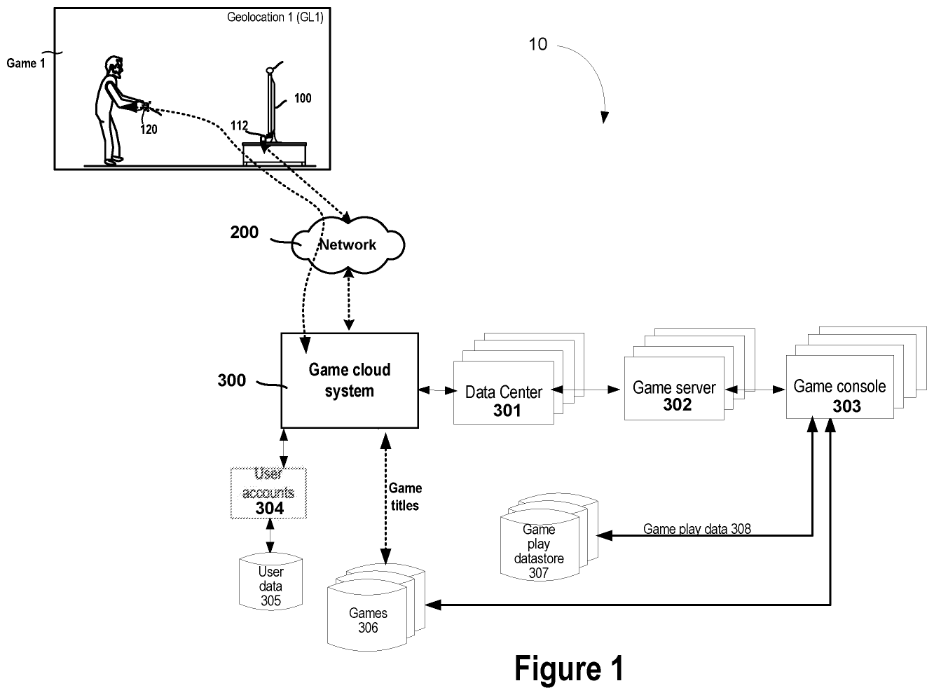

FIG. 1 provides an overview of a game cloud site 10 used for accessing games for game play. The game cloud site 10 includes a plurality of client devices 100 (100-1, 100-2, 100-3, . . . 100-n) distributed in a single geolocation or in different geolocations and communicatively connected to a game cloud system 300 over a network 200. The game cloud system (GCS) 300 is configured to host a plurality of games and other interactive applications, such as social media applications, content provider applications (e.g., music streaming applications, streaming video applications, etc.), etc. The GCS 300 may be accessed from a single geolocation or from a plurality of geolocations. The client devices 100 can be any type of client computing device having a processor, memory, and communication capabilities to access the network 200, such as LAN, wired, wireless or 4G/5G, etc., and may be portable or not portable. The client devices 100 may run an operating system and include network interfaces to access the network 200 or could be thin clients with network interface to communicate with the GCS 300 via network 200, wherein the GCS 300 provides the computation functions. For example, the client devices can be smart phones, mobile devices, tablet computers, desktop computers, personal computers, wearable devices, connected televisions, or hybrids or other digital devices that include monitors or touch screens with a portable form factor.

The client devices 100 having 5G communication capabilities may include mobile devices or any other computing devices that are capable of connecting to 5G networks. In one implementation, the 5G networks are digital cellular networks, where the service areas are divided into a plurality of “cells” (i.e., small geographical areas). Analog data generated at the mobile devices are digitized and transmitted as radio waves to a local antenna within a cell using frequency channels that can be reused in geographically separated cells. The local antenna is connected to Internet and telephone network by a high bandwidth optical fiber or other similar wireless communication. The 5G networks are capable of transmitting data at higher data rates as they use higher frequency radio waves for communication and, as a result, provide lower network latency.

Players may access a video game available at the GCS 10 using a user account. In response to an access request for a game for game play from a player, the user account of the player is verified against user accounts 304 maintained in a user datastore 305. The request is verified against a games datastore 306 to determine if the player is eligible to access and play the video game, prior to providing access to the video game. The verification is done by identifying all the game titles available at the game cloud system 300 that the player is eligible to view or play and validating the game title included in the player's request against the identified game titles. The games datastore 306 maintains a list of game titles that are or can be hosted at the GCS 10 and when new games are introduced, the game titles, game code and information related to the new games are updated to the games datastore 306. It should be noted that although the various embodiments are described in relation to a video game (also referred to as “game”), the embodiments can be extended to include any other interactive applications, such as streaming music applications, streaming video applications, etc.

After successful verification of the user and the request, the game cloud system 300 identifies a data center where the game can be hosted and sends a signal to the identified data center to load the game associated with the game title identified in the request. In some implementations, more than one data center may be hosting or capable of hosting the game. In these implementations, the game cloud system 300 identifies a data center that is geographically proximal to the geolocation of the player. The geolocation of the player may be determined using Global Position System (GPS) mechanism within the client device 100, the client device's IP address, the client device's ping information, the player's social and other online interactions performed via the client device 100, to name a few. Of course, the aforementioned ways to detect the geolocation of the player is provided as example and it should be noted that other types of mechanisms or tools may be used to determine the geolocation of the player. Identifying the data center proximal to the geolocation of the player is to reduce the latency when transmitting game related data between the client device 100 of the player and the game executing at the identified data center 301. The data center 301 may include a plurality of game servers 302 and a game server 302 is selected based on the resources available at the game server 302 for hosting the game. In some implementations, an instance of the game may be executed on one or more game servers 302 either within the identified data center 301 or across multiple data centers 301.

In some implementations, the identified data center 301 may not have the necessary resources (e.g., bandwidth, processing, etc.) to host the game. In such implementations, the game cloud system 300 may identify a second data center that is geographically proximal to the geolocation of the player and has the necessary resources or select ones of the resources to host the game.

The game cloud system 300 loads the game to the one or more game servers 302 in the identified data center(s) 301. The one or more game servers 302 include the hardware/software resources to satisfy the requirements of the game. The game server 302 may be any type of server computing device available in the GCS 300, including a stand-alone server, etc. Further, the game server 302 may manage one or more virtual machines supporting a game processor that executes an instance of the game for the player, on a host.

In some implementations, the one or more servers 302 may include a plurality of game consoles 303 and the game cloud system 300 may identify one or more game consoles within the identified one or more servers 302 to load the game. Each of the one or more game consoles may be an independent game console, or may be a rack-mounted server or a blade server. The blade server, in turn, may include a plurality of server blades with each blade having required circuitry and resources for instantiating a single instance of the game, for example. Of course, the game console described above is exemplary and should not be considered restrictive. Other types of game consoles, including other forms of blade server may also be engaged for executing an instance of the identified game. Once the one or more game consoles or game servers are identified, the generic game-related code for the game is loaded onto the identified game consoles or game servers and made available to the player.

In other implementations, the video game may be executed locally at the client devices 100 and metadata from the executing video game may be transmitted over the network 200 to the game cloud server(s) 302 at an identified data center 301 of the GCS 300 for affecting the game state and for sharing the game play data with other players and spectators.

Game inputs to affect game state of the game may be provided from input devices, such as mouse 112, keyboard (not shown), etc.) or control interface (e.g., touch screen, etc.) associated with the client device 100, or from a hand-held controller (or simply referred to as “controller”) 120 or any other peripheral device that is communicatively connected to the client device 100. Game play data collected from the player's game play session for the game is used to create a haptic learning model (i.e., an artificial intelligence (AI) model). Telemetry data collected during game play of the game is analyzed to extract information (e.g., features) that are indicative of the play style of the player, and the information extracted from the analysis is used to generate the haptic learning model. Additional information collected from ongoing game inputs of the player are used to further train the haptic learning model. The additional information is used to update the play style of the player. The play style of the player is used to determine if the player is getting distracted or is losing focus or is having a hard time keeping pace with the game play or is missing interacting with interactive tasks within the game scenario, etc., which prevents the player from achieving game objective of the game play. The play style is used to determine haptic setting that can be applied to the peripheral devices (i.e., input devices) used by the player to interact with the game. The haptic setting is defined using features of the controller and is customized to the player based on the play style of the player. In some implementations, the haptic setting may be further customized using input from the player, or from another player, or from another user (e.g., a parent or a coach) associated with the player. The customized haptic setting is used to provide the haptic response to the player to warn the player that there is a interactive task that the player needs to interact with in a game scenario, and to guide the player toward the interactive task. The haptic response provides cues to the player to make the player be aware of the interactive tasks in the game scenario that the player can or should interact with, so that the player can interact with the interactive task to obtain the benefits of the interaction.

The video game executed at the game cloud system 300 may be a single player game or a massive multi-player (MMO) game. A game engine (not shown) communicatively connected to game logic of the video game may be used to provide a framework for the video game. The game engine, generally speaking, is a software layer that serves as a foundation for a game, such as the MMO game, and provides the framework that is used to develop the video game. The game engine abstracts the details of doing common related tasks (i.e., game engine tasks) required for every game, while the game developers provide the game logic that provides the details of how the game is to be played. The game engine framework includes a plurality of reusable components for processing several functional portions (i.e., core features) for the video game that bring the video game to life. The basic core features that are processed by the game engine may include physics (e.g., collision detection, collision response, trajectory, movement of object based on gravity, friction, etc.), graphics, audio, artificial intelligence, scripting, animation, networking, streaming, optimization, memory management, threading, localization support, and much more. The reusable components include process engines that are used to process the core features identified for the game.

During game play of the game, the game engine manages the game logic of the game, collects and transmits one or more players inputs received from one or more input devices associated with client devices 100, to the game logic. The game engine further manages, in an optimal manner, the allocation and synchronization of the functional portions of the game engine to process game play data generated by the game logic and generates frames of game content that is transmitted back to the client devices 100 for rendering. A variety of game engines are currently available to provide different core functionalities and an appropriate game engine may be selected based on the functionalities specified for executing the video game. Haptic response generated by a haptic response notification engine is processed by the game engine, encoded and streamed to the client device of the player, in response to detecting interactive task in the game scenario of the video game that requires the player's attention (e.g., interaction).

The game inputs provided by the player during game play correspond to the activities performed by the player in the video game, wherein the activities affect game state of the game. The game inputs of the player are part of telemetry data that is used to generate game play data 308. The game play data 308 and the telemetry data are stored in game play datastore 307. The game state of the video game identifies overall state of the video game at a particular point and is influenced by intricacies of the game play of the player. If the video game is a MMO game, then inputs from a plurality of players are used to influence the overall game state of the video game. The saved data of the player includes any game customization provided by the player for the video game.

The saved data also includes haptic settings customized for the player and such data is saved in the profile of the player. The haptic settings are defined using features of the input device used by the player to provide game inputs to the video game. The features may include buttons, joy sticks, touch screens, etc., of a hand-held controller, or buttons or touch screen of a head mounted display, or controls of peripheral devices, etc. The haptic settings are used to notify the player of an interactive task, or an event occurring in the real-world environment in which the player is present, or to assist the player to accomplish certain tasks within the game, or be alerted to perform certain tasks in the real-world environment, or as behavioral intervention. For example, the player may be too distracted during game play and forget or miss noticing interactive tasks within a game scenario of the video game. Alternately, the player may be hyper-focused (i.e., too immersed) in the game play of the game that they may forget to keep certain appointments or perform certain tasks in the real-world. In other examples, the player may want to play for a pre-defined period of time and would like to be notified as the end of the pre-defined time period is approaching. Alternately, the player may be having a hard time coping with the sensitivity of features of a input device The assistance to the player may be provided as haptic responses to the player. The haptic responses may be provided via the input devices (e.g., hand-held controller used by the player to provide game inputs or wearable devices, such as head mounted displays (HMDs), etc.). The haptic responses may be used to provide directional or spatial cues directing the player's attention toward a specific portion of the game scenario rendering on a screen of a client device of the player. In alternative implementations, where the player needs visual assistance, the haptic responses may be in the form of visual cues (e.g., color coding and/or adjusting color intensity) provided using different input features (e.g., button presses, directional arrow, etc.). In the case where a player has reaction times that are not as sharp or not up to speed expected for the video game, the haptic responses may be in the form of vibrations, pulsations, spinning, jumping, magnetic action (i.e., feeling of restricted movement), reducing response speed to button presses, or swipe actions on touch screen, etc. The haptic response provides a sensible interface for the player using features of the input devices, such as hand-held controllers, etc. The haptic responses are tailored for the player and are intuitive to enable the player to have a satisfying game play experience and not be overwhelmed.

In some implementations, the system used to provide the haptic response, may be able to identify interactive tasks by analyzing context of the game scenario and correlating the context with game actions performed by the player through game inputs provided through input devices. Based on the analysis, the system may detect an interactive task that requires an action from the player, and responsively provide the haptic response making the player aware of the interactive task in the game scenario. The system may continue to provide the haptic response till the player visually sees and interacts with the task. In some implementations, the system may prevent the player from progressing in the game till the player has interacted with the task by deactivating the features of the input device that are used to provide game inputs. The haptic response may be pre-programmed by the system based on the play style of the player. The play style of the player may be obtained from the profile of the player maintained by the system. Alternatively or additionally, the haptic response may be programmed by the player, by another player (e.g., an expert player, a coach, etc.) or by another user associated with the player (e.g., a parent for the player who is a child). Different haptic responses may be programmed for different interactive tasks (e.g., events) that the player may encounter within the game or outside of the game (i.e., in the real-world environment). For example, a directional cue may be indicative of a direction the system expects the player to move to interact with the task or may be indicative of the direction the task exists in the game scenario. In this example, the directional pattern may be rendered on a display screen associated with the client device. In alternate example, the input device may itself vibrate on a side that correlates with the direction the player has to move in the game scenario. A right side vibration or vibration of the right handle of the input device, such as the hand-held controller, may be to instruct the player to move to the right side (e.g., follow the right side path in a fork) or be indicative of the location of the task, in relation to the player, within the game scenario, etc.

Conventionally, input devices, such as hand-held controllers, were generally configured to provide the player with a feel for a type of action that was occurring in the game scenario. Such feedbacks were provided to give the player an immersive experience during game play of the video game. For example, a controller was used to provide a rumble feedback when the player was riding a buggy or a horse-drawn cart on an unpaved road. However, the feedback provided by these conventional input devices was not configured to notify or guide the player to perform certain actions in a game scenario.

The various implementations of the disclosure discussed herein enable the system to track the interactive tasks available in the game scenario, track the interactions of the player to determine which ones of the interactive tasks the player interacted with and which ones of the interactive tasks (or simply referred to as “tasks”) that the player has not interacted with, identify a task that requires action from a player, and guide the player toward the task. It is understood that not all tasks presented in the game scenario have to be interacted with. The system is configured to distinguish specific ones of the tasks that require player interaction and provide the haptic response accordingly. For example, the interactive task may be to interact with a game asset or game object that holds a key to a lock or a tool that may be needed for the player to progress in the game or may include tools that can assist the player in the game play. The system is able to interact with game logic to identify such game assets/game objects and to provide the haptic response guiding the player accordingly. In one implementation, the game asset is part of the game and is represented by characters, objects, environments, vehicles, icons, three-dimensional models, sound effects, music, etc. A game object may be a game asset that can be interacted upon. In some implementations of the present disclosure, the game objects and game assets may be used interchangeably to define a game character, object, icon, environment, vehicle, etc., on which an action can be taken by a player during game play.

The haptic response system (or simply referred to as “response system”) provides the notification (i.e., feedback) by contextually analyzing the content of the game scenario to identify a particular game asset (e.g., interactive task) available in the game scenario that needs the player's attention. The response system interacts with the game logic to perform the contextual analysis in order to determine which ones of the game tasks present in the game scenario are needed for the player's progression in the game, track the player's interaction with each of the game tasks, and notify the player when a particular game task that is needed for the player's progression is overlooked or missed by the player. The assistance provided by the response system helps the player achieve their goals in the game, making the game more interesting to the player. Increase in the interest of the player leads to higher retention rate of the player to the game, which can lead to greater revenue for the game developer or game seller.

The response system may also be configured to provide reminders to the player of pre-defined or scheduled events or appointments outside of the gaming environment or when the player is too immersed in the video game. Alternatively, the response system may be configured to notify the player of events that are scheduled to occur (i.e., upcoming events) within the game, based on the player's progression in the video game. The response system is also configured to provide alarms when the player is too immersed in the video game. The response system tracks the player's interaction to determine amount of time the player has been immersed in game play and provide alarms when the player exceeds a pre-defined period of time of game play. The pre-defined period may be set by the player, by another player, by another user, or by the game logic. The response system may provide notifications for the appointments by interacting with a calendar application (social media calendar, email application, or other calendar applications). Additionally, the response system may notify the players of things or actions occurring in the game play that are interesting.

Further, the notifications provided to the player are customized to the player's needs and play style. The notifications may be haptic responses that may involve sound, and/or color, and/or vibrations. The intensity of the sound, color or vibration may be set to vary to provide directional cues to the player in order to direct the player toward certain areas on the display screen associated with the client device. The haptic responses may be higher fidelity notifications that are customized for the player based on their profile. The player profile may indicate that the player requires visual assistance, or has slow reaction time to the game prompts (e.g., unable to keep up with the speed at which the game prompts are provided in the video game), or is unable to keep up with the speed of game play, etc. Based on the profile, the response system may provide the notifications to the player. The notification is provided by the response system by correlating the content on the display screen with the context of the actions on the screen. The notification is provided in accordance to haptic settings defined for the player. The haptic settings may be defined by the response system by learning the play style of the player, or from input provided by the player themselves, or by other users. The response system includes a haptic learning engine, which is a machine learning algorithm, to define the haptic setting. As the player continues to play the game, the haptic learning engine learns the user's performance in the game, identifies the player's play style, and dynamically adjusts the haptic settings for the player. The adjusted haptic settings may be updated to the profile of the player and used when the player needs to be notified of an interactive task.

In one implementation, the response system uses the telemetry data to determine game progression made by the player and the playing style of the player. The telemetry data is processed to extract specific features that are indicative of the player's progress or lack of progress in the video game. The progress or lack of progress in the video game is determined based on rules defined for the video game. For instance, the telemetry data captures characteristics of each activity that a player attempted, the player accomplished, the player failed, the player did not attempt, etc. These characteristics may be used to determine amount of time taken by the player to accomplish each activity that the player attempted. The extracted features are fed to the haptic learning engine, which learns the play style of the player from the player's responses. As the player plays the video game, the haptic learning engine continues to learn from the player's responses and refine the play style of the player. The haptic learning engine, thus, is able to process telemetry data generated from game play of the video game of a plurality of players and determine the play style of the respective players. In some implementations, the features extracted from the telemetry data of the plurality of players may also be used to determine the play style of the player. For example, the player's play style obtained from the haptic learning engine may be compared against the play style of other players to determine if, compared to other players, the player is a slow learner, or has slow reaction time, or is constantly distracted, etc. Aggregating the player's telemetry data with other players' telemetry data, the haptic learning engine can define a set of haptic settings that can be customized for the player or recommended for the player, based on the player's play style. The haptic settings for the player may be selected from pre-defined settings or may be defined dynamically based on the play style of the player learned by the haptic learning engine. The haptic learning may be executing on more than one server of the game cloud system. The telemetry data may be an aggregate of game play data collected from different game play sessions of the player and of the plurality of other players playing the video game and processed by one or more servers on which the haptic learning engine is executing. The haptic response provided to the player is in accordance with the haptic settings defined for the player. In some implementations, the haptic response is provided through a controller 120 used by the player to provide game inputs. In other implementations, the haptic response may be provided through a wearable or peripheral device, such as a head mounted display (not shown), smart glasses (not shown), etc.

The characteristics identified in the telemetry data are used to define player attributes, which are updated to the profile of the player stored in the user datastore 305, wherein the player attributes are used to identify the game style of the player.

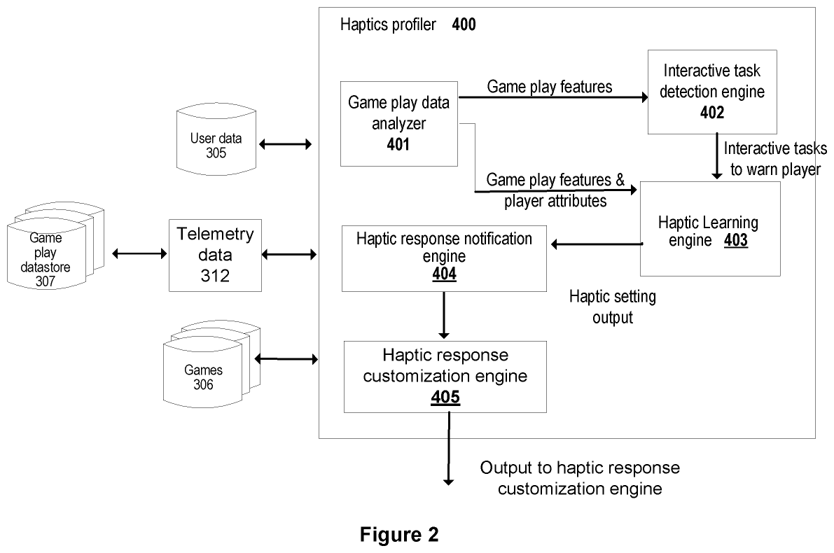

FIG. 2 illustrates a simplified block diagram of a haptics profiler 400 that is used to process the telemetry data generated for a video game from game play of a player to determine play style of the player, in one implementation. The play style is used to determine haptic settings for the player. The haptics profiler 400 includes a plurality of modules that assist in analyzing the telemetry data, determine the play style of the player, and to generate the haptic settings for the player. Some example modules may include a game play data analyzer module 401, an interactive task detection engine 402, a haptic learning engine 403, a haptic response notification engine 404, and a haptic response customization engine 405. Of course, the aforementioned modules are examples and fewer or additional modules may be available for defining the haptic settings for each player playing the video game.

The haptics profiler 400 receives telemetry data 312 from game play datastore 307, wherein the telemetry data includes player related data and games related data. The player related data is stored in user datastore 305 and game related data is stored in games datastore 306. The haptics profiler 400 uses the player related data of each player and game related data of the game as inputs, processes the various data to determine the play style of each player, and generates the haptic settings for each player. The telemetry data 312 includes raw game data of the video game. The raw game data captures the intricacies of game play of a player including game inputs provided by the player, game content provided by game logic in response to the game inputs, game context, etc., for different points in the game play.

A game play data analyzer module 401 processes the telemetry data 312 to extract specific features of game play that are indicative of progress made by the player in the game play. For instance, the specific features may be used to determine if the player is progressing or not progressing in the video game, the amount of progression made in the video game, amount of difficulty in specific portions of the video game, etc., based on rules defined for the video game. The details related to progression made in the video game are used to determine attributes of the player, which are updated to the profile of the player. For example, some of the player's attributes determined from specific features may include expertise level in the video game (e.g., if the player is an expert player, a good player, or a novice player), focus level, play style, etc. Such determination may be made based on amount of time taken by the player to progress through different portions of the game, number of attempts to capture or vanquish a game asset, number of attempts to win a game asset, amount of game assets the player is able to interact with in different portions of the video game, etc. The attributes of the player can be used to determine the player's interest and/or comfort level in the video game. The specific features of game play of the player extracted from the telemetry data 312 are provided to the interactive task detection engine 402 and the haptic learning engine 403 as inputs, for further processing.

In addition to player's attributes the telemetry data 312 may also be used by the game play data analyzer 401 to determine game play features of the video game. The telemetry data 312 includes image data and game play data that are generated in response to game inputs of the player. The game play data analyzer 401 may perform contextual analysis of the image data and game play data included in the telemetry data 312 of the video game to identify the game play features by correlating content of different game scenarios of the video game with context of actions occurring in the respective game scenarios. For example, the game play features may include level of game play, complexity of the video game in different portions of the video game, game scenarios accessed by the player, context of each game scenario, game assets included in each of the different game scenarios accessed by the player, game tasks that are available for interaction in the respective game scenarios, game tasks that are considered important or are considered to assist the player during game play, game state of the video game, etc. The game play features identified from the telemetry data are provided to the interactive task detection engine 402 for further processing. The attributes of the player and the game play features are also provided to the haptic learning engine 403 for generating and training a haptic learning model.

The interactive task detection engine 402 receives the game play features provided by the game play data analyzer 401 and processes the game play features to identify interactive tasks available in the game scenario during game play. The tasks may include interacting with game assets that are available in the game scenario of the video game. The game assets within a game scenario may include static game objects (e.g., tree, rock, hills, mountains, billboards, buildings, treasure chests, locker, magic box, etc.) and dynamic game objects (e.g., shooting star, planes or bombers in a war game, race cars in a racing game, a bus, a person who is exercising or jogging or walking, a competitor or collaborator of the player in a basketball game, football game, soccer game (i.e., an enemy or a teammate from an opposing team, or a teammate who is part of the player's team), etc.), etc. One or more of the game assets (either static game objects or dynamic game objects) may need the player's attention and/or an action to be performed by the player. These game assets may be needed for the player to progress in the video game or may provide assistance to the player during game play. For example, the interactive task (i.e., a game asset) that need the player to act on in a game scenario may be a magic box, or a treasure chest, that holds a key to unlock a room or a key to a castle, an ammunition, a tool, a clue, etc., to assist the player to progress in the video game. Due to speed of game play or due to the location of the game asset related to the interactive task in the game scenario, the player may have missed seeing this game asset. The interactive task detection engine 402 interacts with the game logic to keep track of the interactions of the player in the video game to identify the game assets available in the game scenario, game assets that the player interacted with, and game assets (e.g., treasure chest, a safe, a box, etc.) that hold tools/clues/keys for the use of the player during game play. Using this information, the interactive task detection engine 402 is able to identify a specific game asset that holds the clue/tool/key that the player missed when interacting in the game scenario. The information identified by the interactive task detection engine 402 is provided as input to the haptic learning engine 403.

In addition to identifying the interactive tasks associated with the one or more game assets the player missed performing in the game scenario, the interactive task detection engine 402 may also determine a reason the player missed performing the interactive tasks. The reason for missing interacting with a interactive task may be due to slow reaction time of the player, the player being overwhelmed by the speed of game play (i.e., too many interactive tasks present in a game scenario for player interaction, or speed at which the interactive tasks are being presented, etc.), the player running out of time, the player getting distracted or not focused, etc. The interactive task detection engine 402 is configured to analyze the game play data of the player to determine the speed at which the player interacts in the video game (i.e., reaction time), the speed of game play (i.e., game play intensity), the speed at which the interactive tasks are being presented, the amount of time available to the player, etc. From the analysis, the interactive task detection engine 402 is able to identify a reason for the player missing interacting with a specific game asset associated with the interactive task. The information from the analysis by the interactive task detection engine 402 is provided to the haptic learning engine 403.

The haptic learning engine 403 includes machine learning algorithm that uses the game play features and player attributes provided by the game play data analyzer 401 and the interactive task related information provided by the interactive task detection engine 402 to generate and train a haptic learning model (not shown). The player attributes identify the play style of the player. The haptic learning engine 403 trains the haptic learning model using telemetry data 312 of the player. The haptic learning model may also use the telemetry data 312 of a plurality of other players that have played the game to fine tune the haptic learning model generated for the player. The finely tuned haptic learning model is used to identify specific haptic setting output that is appropriate to satisfy the game playing objective of the player. The specific haptic setting output is customized for the profile of the player, based on the play style of the player.

The haptic setting output identified from the haptic learning engine 403 is provided as input to the haptic response notification engine 404. The haptic response notification engine 404 defines the haptic settings for different features identified in the haptic setting output. The haptic settings are provided as input to the haptic response customization engine 405 so as to define and provide a customized feedback to the player during game play. The customized feedback, in accordance to the haptic setting for the player, may be provided via a controller or via a wearable device, such as head mounted display, a smart watch, smart glasses, other peripheral device, etc., used to provide game inputs by the player. The customized feedback is provided to the player to direct the player's attention to the game asset that the player missed to perform the task. The feedback may continue till the player interacts with the game and performs the task. In some implementations, the feedback may prevent the player from moving forward in the game till the player interacts with the game asset and completes the task. In alternate implementations, the player may be provided with informational feedback stating that the player missed interacting with the game asset. The informational feedback may be in the form of highlighting or visually identifying the game asset, or textual or voice feedback. In some implementations, the feedback may include directional cues guiding the player to the game asset so that the player can perform the task.

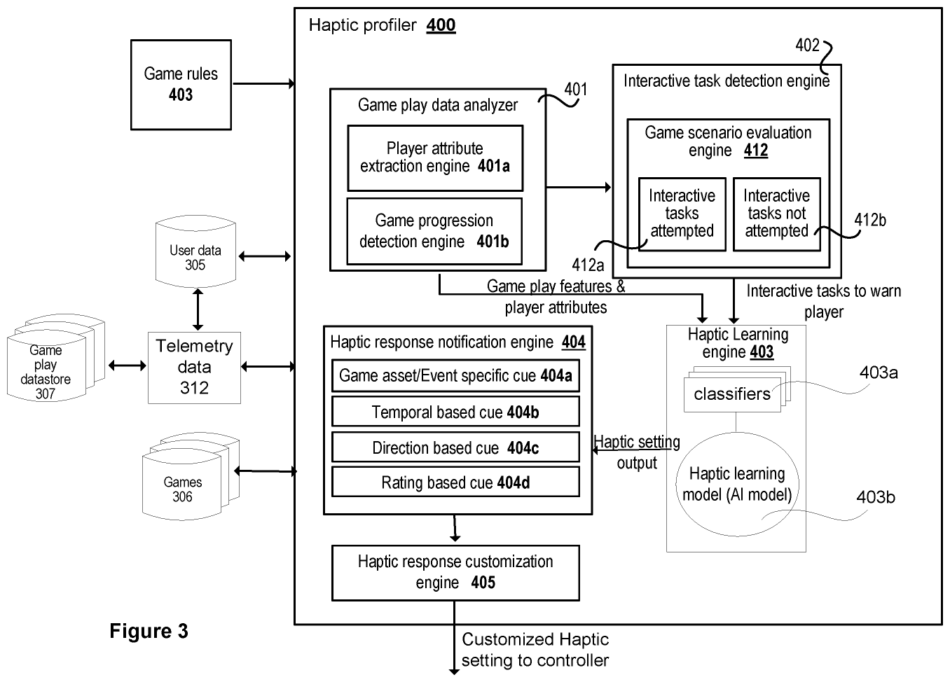

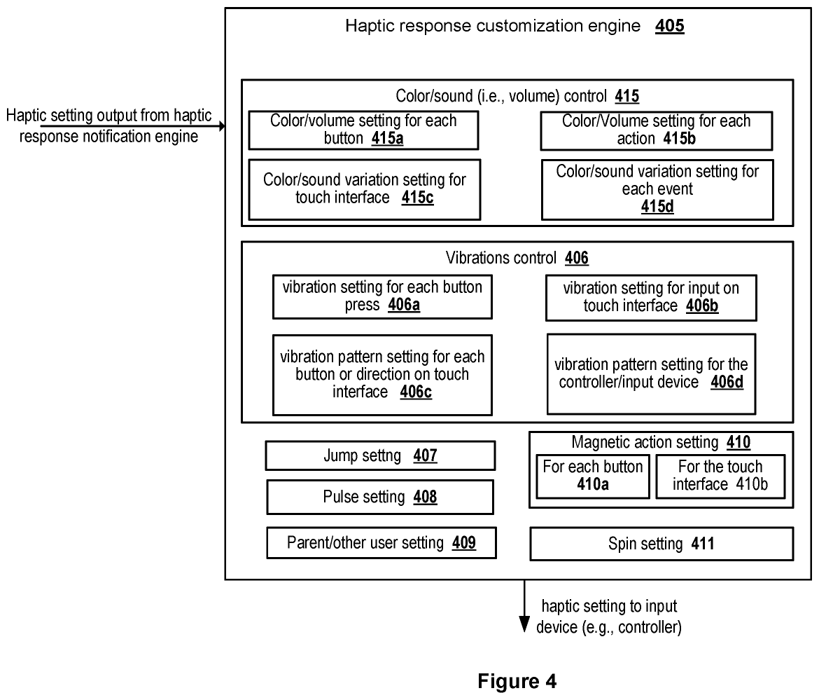

FIG. 3 illustrates a simplified block diagram of different sub-modules within the various modules of the haptic profile shown in FIG. 2, in accordance with one implementation. For example, the game play data analyzer 401 includes a player attributes extraction engine 401a and a game progression detection engine 401b. Similarly, interactive task detection engine 402 includes game scenario evaluation engine 412 to identify the tasks attempted 412a and tasks not attempted 412b by the player. The haptic learning engine 403 includes a plurality of classifiers 403a and a haptic learning model (an artificial intelligence model) 403b to identify haptic setting output for the player. The haptic response notification engine 404 includes a plurality of sub-modules including a game asset/event specific cue engine 404a, a temporal based cue engine 404b, a direction based cue engine 404c, and a rating based cue engine 404d, to name a few. The various modules included within the haptic response customization engine 405 will be discussed in detail with reference to FIG. 4.

The game play data analyzer 401 is configured to analyze the game play data included in the telemetry data 312 to identify the game play features and player attributes. The telemetry data 312 is stored in a telemetry datastore (not shown) and is provided as input to the haptic profiler 400 for processing. A player attribute extraction engine 401a is used to parse the game play data to identify and extract specific features related to the player. Some of the player related features that may be extracted include player game inputs, time taken by the player to respond to game prompts, game assets targeted by the game inputs, skill level of the player, etc. The extracted player specific features are used to define player attributes (e.g., skill level of the player, the reaction time of the player, the focus/distraction level, etc.) of the player by the game play data analyzer 401. The attributes of the player defined from the telemetry data are used to dynamically update user profile stored in the user datastore 305 and used as input for a haptic learning engine 403 to identify a haptic setting output for the player. The telemetry data 312 may be an aggregate of game play of a plurality of players. As such, the various modules of the haptic profiler 400 identify attributes of not only the current player but of each of the other players and use the attributes of the other players to fine tune some of the attributes of the player.

A game progression detection engine 401b of the game play data analyzer 401 uses the game play features and attributes of the player and game details provided by the game logic to determine the game progression made by the player in the video game. In some implementations, the attributes of the player determined from previous game play session may be dynamically updated using game play data of the current game play session. In some implementations, the game progression detection engine 401b may also consider the game play features and attributes of other players that have played the video game to determine the game progression made by the player in relation to the game progression made by other players. The updated attributes of the player are stored in the player's profile maintained in the user datastore 305. The game progression made by the player is used by the haptic learning engine 403 to define the play style of the player, wherein the play style is based on reaction time to game prompts, challenges overcome, game assets captured, game assets missed, tasks attempted, tasks not attempted, etc.

The game progression details extracted by the game progression detection engine 401b and the game play data of the player are used by interactive task detection engine 402 to determine specific one of interactive task missed by the player in the game scenario rendered on a display screen of the client device associated with the player. A game scenario evaluation engine 412 of the interactive task detection engine 402 evaluates the game play data and the game progression data of the player to identify a specific one of the interactive tasks that the player missed interacting with but should have in the game scenario of the video game. The game scenario evaluation engine 412 correlates the content of the game scenario currently rendering on the client device of the player with context of actions performed by the player to determine the interactive tasks (i.e., actions on game assets) that are available in the game scenario, the interactive tasks that the player attempted 412a and interactive tasks that the player did not attempt 412b. The interactive tasks may correspond to actions that are to be performed on game assets that are static in nature (i.e., fixed objects—e.g., trees, mountains, houses, streets, etc.) or dynamic in nature (i.e., moving objects—e.g., flying objects/missiles, launched game objects, moving vehicles, etc.). The game scenario evaluation engine 412, with information obtained from the game logic, is configured to identify specific one of the game assets holds a key or an object or a clue that may be necessary for progression in the game and the task that needs to be performed on the game object by the player. There may be multiple game assets in the game scenario and not all game assets have to be interacted with or hold key/clue/tool necessary to progress in the game. For instance, some of the game assets may be presented to the player for pure entertainment or to allow the player to gain additional points in the game and, as such, these game assets may not be necessary to progress in the game. The game scenario evaluation engine 412 uses the context of the content presented in the game scenario and the actions performed by the player to identify all the tasks not attempted 412b by the player, filter out specific ones of the un-attempted tasks 412b in order to identify an interactive task that is needed or holds a key or clue for progressing in the video game.

The task information from the interactive task detection engine 402 along with the game play features and player attributes identified by the game play data analyzer 401 are provided as inputs to the haptic learning engine 403 for generating and training a haptic learning model. The haptic learning engine 403 is a machine learning algorithm that includes a plurality of classifiers and a haptic learning model, which is an artificial intelligence (AI) model generated by the machine learning algorithm. The haptic learning model is generated by the haptic profiler 400 to learn the play style of the player in order to determine if the player needs assistance during game play, and to identify a haptic setting output that can be used to notify the player or provide assistance to the player to accomplish the game objective of the player—interact with the game asset and make progress in the game, for example. The attributes of the player and the game play features of the video game are used to define classifiers. Each classifier may be defined using one or more attributes of the player, and/or one or more game play features of the game. The classifiers are used to generate the haptic learning model 403b. The haptic learning model 403b is fine-tuned using additional game play features of the game identified during the current game play session of the game. Additional fine-tune of the haptic learning model 403b is done using player attributes and game play features of a plurality of other players that have played or are currently playing the game. The fine-tuning of the haptic learning model 403b may be done dynamically. The features and attributes gathered from the game play of the plurality of other players define the play style of the other players. The play style of the other players can be used to compare against the play style of the current player to determine a state of the current player (e.g., is the player distracted, or is unable to cope with the speed of the game, or has difficulty recognizing certain one of the interactive tasks based on the interactive tasks' attributes (e.g., location of the corresponding game asset in the game scenario, display attributes of the game asset, amount of content present in the vicinity of the game asset in the game scenario, etc.) during game play. The haptic learning model 403b may be generated for each player and fine-tuned with features and attributes identified from other players game play. The finely-tuned haptic learning model 403b can be used to identify the haptic setting output that matches the play style of the player.

Although various implementations are discussed extensively with reference to the player being provided with haptic response to remind them to interact with a specific interactive task to progress in the game or to notify the player of the presence of a game asset in the game scenario that needs action of the player, the implementations may be extended to provide feedback or notification to the player for a specific event that is about to happen or should happen or is currently occurring in the game, or to provide an alarm to notify the player that a pre-defined period of time set aside for playing the game is about to expire or when a pre-defined period of time for when the player should not be disturbed is about to expire, or to provide notification when a calendar event is due, or when an event in the real-world environment is scheduled to occur, etc. The haptic setting output may be identified to provide a reactionary notification or a pro-active notification to alert the player. For example, the haptic setting output selected for the player may be a reactionary response to notify the player that the player is choosing an incorrect move or incorrect tool/weapon to perform a specific interactive task in the game scenario, during game play. Alternatively, the haptic setting output may provide a pro-active response to notify the player of specific challenges that lie ahead for the player in the game scenario.

The haptic response output identified by the haptic learning engine 403 is provided as input to the haptic response notification engine 404 for further processing. The haptic response notification engine 404 processes the haptic response output to identify various forms of notification identified in the haptic setting output so that appropriate cues can be provided for customizing the haptic response provided to the player. The haptic setting output identified for the current player playing the game may be event specific, visual object or game asset specific, temporal specific, direction specific, rating specific, etc. The haptic response notification engine 404 includes a plurality of sub-modules to process the type of notifications included in the haptic setting output so that the haptic response provided to the player can be tailored accordingly. For example, when the haptic setting output includes an event or game asset specific notification, a game asset/event specific cue engine 404a may be used to identify an appropriate cue that corresponds with the event specific or the game asset specific notification so that the haptic response to the player can include the appropriate customization to notify or nudge the player. The customization may be to direct the attention of the player to the specific event or the specific game asset. For instance, if the player missed seeing the specific game asset, or missed interacting with the specific game asset, or missed taking a right turn (i.e., a specific event) etc., the game asset/event specific cue engine 404a will identify the event specific or game asset specific cue that can be used to provide the event specific or game asset specific notification to the player. The cue identified using the game asset/event specific cue engine 404a may be a spatial cue that maps the game asset or the event to a location within the game scenario using a three-dimensional representation of the game scenario. The spatial cue may be used to inform the player a location of the game asset or the location where the event is occurring in the game (e.g., location in the game scenario where the player missed taking the right turn).

A temporal based cue engine 404b may be used to identify a temporal cue that can be used to customize the notification to the player to inform the player whenever a time-related event or action is about to occur or is scheduled to occur or is set to expire. For example, a player or another player (e.g., a coach, a teacher, etc.) or another user (e.g., a parent) associated with the player may define a pre-defined period during which time the player is not to be disturbed. During the pre-defined period, the player may be involved in game play or may be involved in interacting with another interactive application or may be involved in another activity. Based on the temporal based event or action, the temporal based cue engine 404b may identify a particular temporal cue that is to be used to inform the player of the temporal based event or action that is due or is about to come due or is about to expire. Using the temporal cue, a notification may be generated to provide an alarm, wherein the alarm may be an audio feedback (e.g., set to a particular tune), or as a haptic feedback, or as a visual feedback, etc.

A direction based cue engine 404c may be used to process the direction based notification included in the haptic setting output in order to identify directional cues that can be used to provide location-based notification to the player. The directional cues may be to guide the player toward a particular portion of the screen that is rendering the game scenario of the game or toward a specific content of an interactive application. The directional cues may be provided using features of an input device that is used by the player to provide game inputs. For example, the input device may be the hand-held controller or the wearable device, such as smart watch, glasses, etc. In some implementations, the directional cue may be used to provide notification on the screen of the client device. In alternate implementations, the directional cue may be used to provide haptic notification at the input device itself. For example, when the player's attention needs to be directed toward the right side of the screen or the player has to make a right turn at a street intersection, the directional cue may be used to provide vibration feedback to the right side of the hand-held controller or alternatively a visual feedback on an interactive touch screen of the hand-held controller—e.g., a lighted arrow head configured to move from left to right. Additionally, the intensity of the light and/or the size of the arrow head may be varied to indicate to the player to move in the direction identified in the directional cue in order to interact with the interactive task. In one implementation, the directional cue may be used to manipulate features of the hand-held controller 120 to provide the direction based notification. In this implementation, the directional cue may be used to sequentially activate a plurality of haptic elements that are included in the controller 120, in the direction specified in the direction cue. The haptic elements may be used along with other components (e.g., accelerometers, magnetometers, gyroscopes, inertial measurement units (IMUs), other sensors, or combinations thereof) of the controller 120 to provide haptic feedback, sound feedback, visual feedback, etc., to the player by activating the specific modes of the haptic elements, other components.

A rating based cue engine 404d is used to process the haptic setting output to identify the type of notification that needs to be provided to the player and to adjust the level of feedback provided in the notification to the player. When the haptic response notification engine 404 requires the player to move in a particular direction, the rating based cue engine 404d may be used to enhance the feedback provided to the player via the various elements, components of the controller 120. The enhancement in the feedback may be provided by adjusting the settings of the haptic elements and/or the other components of the controller 120. For example, the rating based cue engine 404d may be used to increase the haptic response by increasing the revolutions per minute (rpm) of the vibration from a lower rpm to a higher rpm. The amount to which the rpms are increased may be based on the profile of the player and is specific to the player so as to ensure that the player is able to recognize the feedback and react accordingly. The various cue engines may act together to identify cues for providing more than one type of notification to the player. The types of cues, the intensity of notification, and length of notification may be defined in accordance to the player's profile or in accordance to the specifics provided by the player or by another user. Further, the notification is continued to be provided to the player till the haptic profiler 400 detects the player performing the action or move needed in the game. The notification is to ensure that the player reacts in an appropriate manner when interacting within the game, or to assist the player to progress in the game, or to notify the player of certain behavior required of the player, or as a behavior intervention tool to ensure player's safety or benefit.

The respective cue engines may be configured to enhance the intensity of the notification to ensure that the player does not ignore the different types of notification. In some implementations, the cue engines may be configured to prevent the player from progressing till the player has completed the action related to the game asset or event associated with the notification. In such implementations, the cue engines may be configured to deactivate the controls of the input device till the player performs the required action or behaves in a certain way. Upon detecting the player's action or behavior in response to the event or at the game asset or during game play, the controls of the input device may be re-activated to enable the player to continue with the game. The haptic settings are used to customize the haptic response forwarded to the input device so that the input device can provide the haptic response to the player.

FIG. 4 illustrates an example of a haptic response customization engine 405 that can be used to define and/or adjust various settings for different controls of an input device that is used to provide haptic response, based on the cues provided by the various cue engines of the haptic response notification engine 404, in one implementation. For example, based on the cues provided by the cue engines, a color/sound control engine 415 of the haptic response customization engine 405 may be used for setting color for different controls of the input device, such as the hand-held controller (or simply referred to as “controller”) 120. The color/sound control setting may be defined for each button (415a) or some of the buttons on the controller 120, for each action (415b) (e.g., moving in correct direction vs. moving in incorrect direction, selecting correct weapon vs. selecting incorrect weapon to interact in a game scenario, etc.), for any touch screen interface available on the controller 120 (415c) (e.g., a first color setting to inform the player that a swipe action provided by the player is in the right direction, a second color setting to inform the player that the swipe action provided by the player is in the wrong direction, etc.), and for each event (415d) (e.g., when approaching the end of a pre-defined period, or when a calendar event is coming due or is scheduled, etc.).

In one implementation, in addition to defining visual and/or audio setting (i.e., color/volume setting) for the different controls of the input device (e.g., controller 120), the haptic response customization engine 405 may be configured to provide haptic settings for the different controls of the input device. A vibrations control engine 406 of the haptic response customization engine 405 may be used to set the haptic settings for the different controls. In one implementation, the vibrations control engine 406 may be configured to define vibration setting (406a) for each button press of a controller, or for input on a touch interface (406b), or to define vibration pattern setting for each button or direction on touch interface (406c), or to define vibration pattern setting for the input device itself (406d). For example, the vibration pattern setting may include defining a color/sound/haptic feedback for a sequence of button presses, for a sequence of inputs (e.g., swipe gesture) provided on touch screen. The vibration pattern may be set to increase in intensity of the color, sound or haptic feedback, in response to sequence of inputs going in a particular direction and decrease in intensity in the opposite direction. In another example, the vibration pattern may be set for the input device, such as the controller itself. For instance, when the haptics profiler 400 wants the player to make a right turn at an intersection, a haptic response may be triggered at the controller. When triggered, the haptic response is customized to cause the right side or right handle of the controller to vibrate (i.e., haptic feedback) to indicate to the player that the player has to make a right turn. Further, as the player gets closer to the intersection, the vibration may be set to increase to signal the player that the player is getting close to the intersection or is passing. The haptic response, in this example, is event based. For a temporal based notification, the haptic response may be provided to the player by causing the whole controller to vibrate, for example. In addition to haptic feedback, additional feedback in the form of sound, color, text, etc., may also be provided either at the controller 120 or at the display screen of the client device.

The haptic response customization engine 405 may also customize a jump setting 407 based on the cues provided by the different cue engines. For example, the jump setting 407 may be customized for the player by defining a length, a height, a speed, etc., of jump performed when the player activates the jump control during game play. One of the controls (e.g., button) on the controller, for example, may be mapped to the jump action and this button may be customized for the player in accordance to the jump setting defined by the haptic response customization engine 405.

The haptic response customization engine 405 may provide additional customizations when defining a pulse setting 408, parent/other user setting 409, magnetic action setting 410, and/or spin setting 411. For instance, the pulse setting 408 may be customized to provide appropriate physical and visual feedback to the player through the input device. In some implementations, the input device may be a wearable controller, such as a wrist gear, and the customized pulse setting may cause visual display to be projected on a desired surface, such as a user's arms, palms, etc., to give the player a sense of orientation. The visual displays may be static visuals or interactive visuals. The player can touch and use the projected image and the pulse settings may be customized for the player to allow the player to interact with the visual display. The pulse setting for the wearable controller may also include a haptic setting to allow the player to experience physical feedback from the interaction performed at the projected image.

In one implementation, the haptic response customization engine 405 may also define parent/other user setting 409 to enable a parent or other user (e.g., a coach, another player, a teacher, etc.) to provide customizations for the player. The parent/other user setting 409 may specify the controls that can be customized. The parent or other user can customize the controls to provide temporal or access limitations for the player, define vibration setting, color/volume setting, vibration pattern setting, jump setting, pulse setting, etc., in accordance to the profile of the player.

In one implementation, the haptic response customization engine 405 may define magnetic action setting 410 for the input device, such as the controller 120. The magnetic action setting 410 may be to define resistance setting for one or more controls of the input device (e.g., buttons on the controller 120), so that when the button is pressed by the player, the player experiences a feeling of restricted movement (e.g., a drag). For example, in a driving game, the player is supposed to turn right at an intersection. However, the player may not have been paying attention and instead may have started to drive straight. As the player approaches or is trying to go past the intersection, the magnetic action setting defined for the one or more controls used by the player (e.g., a button or joy stick used for driving the vehicle) would provide a force or resistance to warn the user to turn right and to not go straight. The magnetic action setting 410 may be customized to provide appropriate resistance when the button is activated and the wrong direction is selected by the player. Similarly, when the player moves in the correct direction, the magnetic action setting 410 may relax the resistance so as to allow the player to accelerate after taking the correct turn. In addition to the resistance provided by the magnetic action setting 410, directional haptics of the controller 120 may also be activated to provide the player with additional notification for the direction the player is traveling and the direction the player has to move/travel in the game. The directional haptics of the controller are set based on direction based cue engine 404c, or event specific/game asset specific cue engine 404a of the haptic response notification engine 404. For example, the directional haptics may be defined to provide vibrations at the controller starting at the left hand side (e.g., left handle) and moving toward the right hand side (e.g., right handle) to notify the player the direction the player has to move in the game. The directional haptics may also be configured to increase in intensity as the player approaches the intersection where the player needs to make the right turn. The increase in intensity is to ensure that the player is able to feel the haptic feedback provided by the controller as the haptic feedback moves within the body of the controller from left to right. The controller includes a plurality of haptic elements and the haptic feedback is provided to the player by configuring the haptic elements of the controller to work together to allow the haptic feedback to progress from one haptic element to another haptic element in a desired direction to convey directional cue. The magnetic action setting 410 may be defined for each button or control 410a of the input device and for the touch interface 410b. Thus, when the player needs to be notified to perform certain action in the game, the magnetic action setting 410 of a button or the touch interface may be activated.

In some implementation, based on the ratings cue provided by the cue engines the rating of the haptic feedback may be increased or decreased. For example, the ratings cue may be used to define spin setting 411 of the haptic feedback provided via the input device. The spin setting 411, in one implementation, defines the spin ratings of the haptic feedback provided to the player. The spin ratings may be set by defining low revolutions per minute (rpm) and a high rpm that the haptic feedback can spin. The low rpm and the high rpm defined for the spin rating may be specific for the player and may be based on the profile of the player. The player specific setting is to ensure that the player is able to feel and differentiate the haptic feedback spinning at the low rpm and the high rpm.

The various types of customization of the controls of the input device performed by the haptic response customization engine 405 are in accordance to the cues provided by the cue engines and are provided as examples. Additional or fewer customization of the controls can also be envisioned. The customization of the controls is specific to the player and is done to provide event specific, game asset specific, direction specific, rating specific, and/or temporal specific notifications to the player. The haptic learning engine 403 uses the game inputs of the player to learn the play style of the player, compare the play style of the player against play style of other players, compare the game inputs of the player against the game logic of the game to determine the type and frequency of notifications that need to be provided to the player, and identify the appropriate notification setting when customizing the notification to the player. The notification setting for customizing the notification may be determined dynamically during game play of the player so that appropriate notification settings may be applied to controls of the input device during the game play. The feedback provided via the controls of the input device may be haptics feedback that gives directionality context of the game, and such feedback may be provided in advance of any action or during the action performed by the player.

In some implementations, customization of the notification provided using controls of the input device may be part of a development tool that is used by the game logic of the game. In this implementation, the notification is not part of the game logic but available to the game logic for application during game play. The customizable profile of the input device (e.g., controllers) act as alarm or notification device to provide assistance during game play by alerting the player of ongoing or upcoming events, actions or interactive tasks that the player has to perform in the game, etc. The customization of input device profile allows for setting up date, time, duration of alarm/notifications, setting the feedback of choice (e.g., haptic, audio, text, color, etc.), setting intensity of colors/sound/volume for each button or control action, allowing other players (e.g., coach, teacher, parent, etc.) to have remote access to control the notification provided by the input device, and setting up different types and levels of haptic feedback (e.g., vibration, pulse, spin, jump, magnetic action, lag in command, etc.). The lag in command option allows for setting up the controls of the input device for slower response. This option may allow the player to provide action at a speed that is comfortable to the player. The notification provided by the input devices may be in addition to the prompts provided by the interactive application (e.g., regular game prompts provided in a game). The notification is provided to stimulate or nudge the player to perform a certain action on an interactive task (e.g., a visual game object) and the notification may be set up to continue till an action from the player is detected at the interactive task. The controls of the input device may be customized for providing notification that are specific for different events, for different actions, for different controls of the input device, for different players, etc., and the customization may be done using pre-programmed settings, or as specified by the player or other player/user.

The player may like to play the game but may grow frustrated when they are unable to reach certain goals. This may be due to the player having a different play style and may need more time to react to the prompts within the game to achieve the goals. In order to make the games more interesting to the player, the game play of the game may be customized to the play style of the player. For example, when the player has slow reaction time to the game prompts, the lag in command option may be used to customize the controls of the input device, so that when the player uses the controls, the responses provided by the activated controls are slower. In response to detecting the slow response, the game logic may automatically reduce the speed of the game. The customization defined for the controls of the input device may or may not include inputs from the player but may be performed in an intuitive manner, such that when the notification is provided to the player, the notifications are easily understood by the player. Customization of the input device profile (e.g., controller profile) may be performed to accommodate various play styles, visual and/or other game needs of the players. The ability to customize the controls allows setting up the color scheme and setting up the intensity of the feedback (e.g., stronger or weaker haptic signals, brighter or duller colors, volume setting, etc.).

To summarize, the haptic learning engine 403 of the haptic profiler 400 is configured to learn from the player's game progression to pick cues on whether the player is or is not able to understand the visual content provided in the game. Based on this learning, the haptic learning engine determines the type of haptic response that has to be provided to the player. The haptic learning engine identifies the haptic setting output that is used to identify the haptic settings that are needed to customize the notification provided to the player, and dynamically applies the haptic settings to the input device, such as the controller, head mounted display, wearable device, or any other peripheral device, as the player is playing the game. As the player continues to play the game, the haptic learning engine 403 continues to learn from the player's performance in the game, and dynamically adjusts the haptic settings applied to the input device. The haptic settings identified for the player may be based on in-game events/actions or out-of-game events/actions. In some implementation, the haptic settings may be identified based on pre-settings defined in the profile of the player. For example, the pre-setting may indicate that if the player is involved in game play for more than a pre-defined period of time, the notification has to be triggered. In another example, the player may want to play the game and may not want to be disturbed with any distractions for a pre-defined period of time. In both the examples, the pre-settings defined in the player's profile may be used to generate the notification to the player before or just after the pre-defined period of time expires. The notification may be customized so that the player's game play is not interrupted but provide a gentle nudge using haptic or audio feedback, for example, to warn the user of the expiration of the time. In addition to the haptic or audio feedback, the notification may provide spatial cues of where the player is going or not going or should be going in the game world, as the player is moving around in the game.

In one implementation, the notification may be set up to provide notification based on the context of game play and the action detected or expected from the player. For example, the notification may be provided to indicate to the player that the player is choosing a correct or incorrect weapon or tool or move in the game. Additionally, the notification may be set up to show how the other players, especially the player's friends or social contacts, navigated in the game or interacted with a specific game asset or used the weapon or tool to perform a task. In some implementation, the haptic learning model 403b may be tuned using game play features and attributes of specific ones of the players (e.g., player's friends or social contacts) so that the haptic setting used for customizing the feedback to the player may be in accordance to what was learned from the game play of the player's friends or social contacts.

In some implementations, the haptic setting identified for the player allows tuning the input device for variations in feedback. For example, a spin setting on the controller can be tuned to go from lower rpm (revolutions per minute) to higher rpm, wherein the lower rpm may be set to indicate an incorrect move (e.g., picking the correct weapon or tool, or the wrong direction) and the higher rpm may indicate a correct move. Additionally, the spin setting can be defined to behave differently for different actions or cues, such that the spin setting can dynamically change from a first setting to a second setting based on changes in the actions of the player detected in the game. Thus, the haptic setting output from the haptic learning engine can be used to set feedback to indicate different meanings to the player and such feedback is intuitive to the player. The intuitive and variable feedback to the player is provided by tuning the various elements of the controller (i.e., input device) that are used to provide haptic, visual, audio, and other feedback.

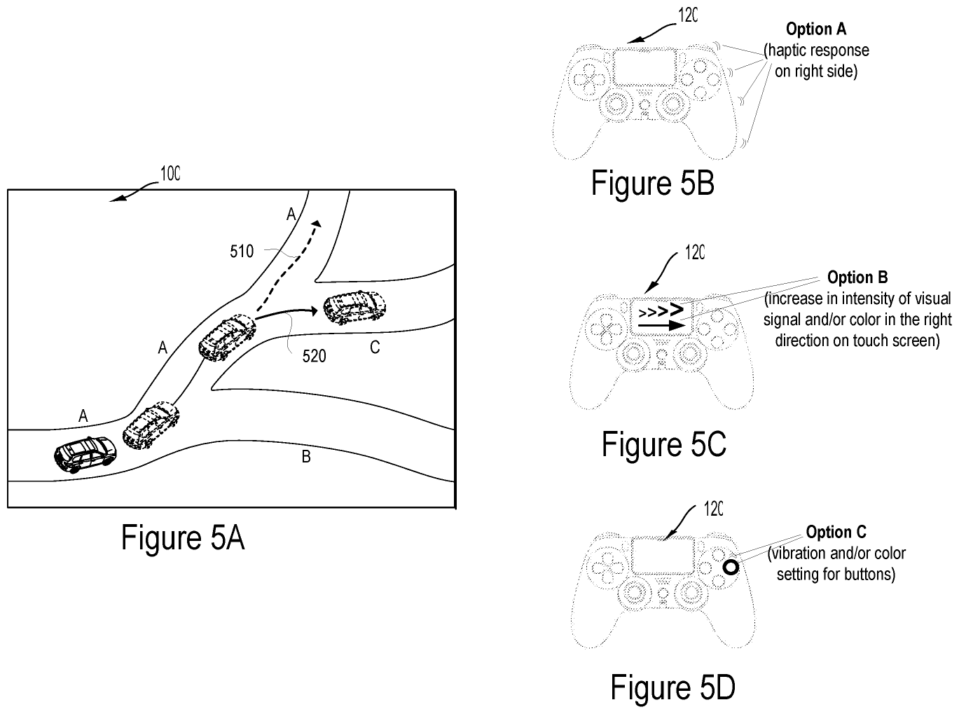

FIG. 5A illustrates a game scenario of a video game generated from game inputs provided by player, in one example implementation. The game scenario includes a vehicle traveling on a path A with various paths (e.g., paths B and C) branching off of path A that the player can choose to take during game play. As the player proceeds on path A, a task or a game object or path to achieve a goal may be identified along path C. As the player approaches the fork to path C, the player may be provided with a notification to follow path C instead of continuing on path A. FIGS. 5B-5D illustrate some of the setting options that may be used for customizing notifications using controls of a hand-held controller, in some implementations. The customization, as mentioned previously, is done using haptic setting output identified by the haptic learning model 403b. The customization settings can be defined for the controller and for each control button or input interface of the controller 120. FIG. 5B illustrates one such option, option A, wherein the notification setting is defined for the controller, in one implementation. The notification setting is defined in a manner that allows haptic response to be provided on a side of the controller 120 that corresponds with a side the player has to proceed. In the example illustrated in FIG. 5B, the player is nudged to proceed on the right side of the fork toward path C (illustrated by solid line 520) instead of continuing on path A (illustrated by broken line 510) by causing the controller or handle of the controller to vibrate on the right side. Similar notification may be provided to the player if the haptic profiler wants the player to direct their attention to the right side of the screen. FIG. 5C illustrates another option, option B, wherein the notification setting is defined for the input interface of the input device (e.g., touch screen of the controller 120), in one implementation. In the example illustrated in FIG. 5C, a directional cue is provided on the touch screen using arrow heads moving from left to right (shown by the directional arrow) to indicate the direction the haptic profiler wants the player to proceed or pay attention to in the game scenario rendered on the display screen 100. In one implementation, the intensity of the directional cue may increase from left to right to provide additional feedback to the player. In addition to visual cue, the notification may also include audio cues. For example, as the arrow heads move from left to right the audio cue may increase in volume or provide a distinct sound. Alternatively, special audio tunes may be set up either by the player or for the player to indicate the direction the player has to direct their attention to in the game or on the display screen rendering the game play. In some implementation, separate audio tunes may be set to indicate a correct direction or an incorrect direction.

FIG. 5D illustrates yet another setting option, option C, wherein each button on the controller 120 is set to provide a notification/feedback, in one implementation. The setting of each button may be defined differently to indicate different feedback responses to the player. For example, each button may be set to provide a haptic feedback. In place of or in addition to haptic feedback, each button may also include visual setting by allowing each button to light up in a different color or in different sequence of colors to indicate to the player the different button presses (single press vs. multiple presses) that the player is performing or has to perform. It should be noted that the various setting options described with reference to FIGS. 5B-5D have been described in relation to various settings for different controls on a controller for providing haptic and/or visual feedback. The feedback is not restricted to the two specified feedbacks or the controller. Further, the setting options shown in FIGS. 5B-5D are exemplary and additional input devices and additional feedback in the form of audio, etc., may also be provided to the player.

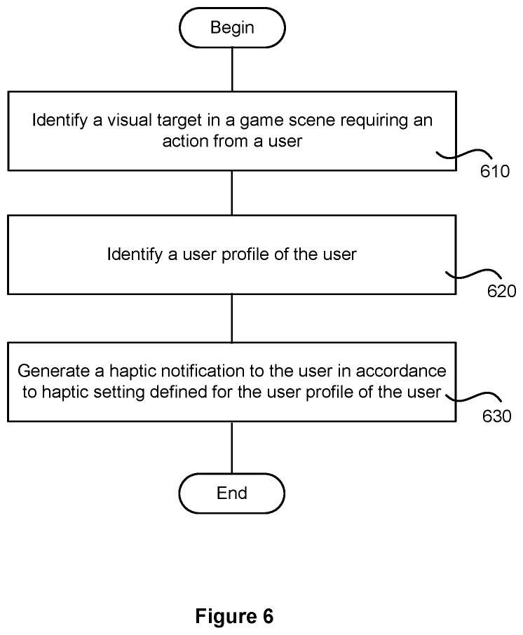

FIG. 6 illustrates flow of operations of a method for providing notification to a player during game play of a video game, in one implementation, to allow the player to have a satisfactory game play experience. The method begins when an interactive task is detected within a game scenario of the video game that requires an action from the player, as illustrated in operation 610. The player logs in to game cloud system 300 and selects a video game for game play. The game cloud system 300 verifies the authenticity of the request for game play of the video game by accessing the user account 304 of the player stored in the user datastore 305, and the game titles in the games datastore 306 to determine if the player is authorized to access and play the video game. Upon successful authentication, an instance of the video game is executed on one or more game servers 302 in one or more data centers 301 of the game cloud system 300. Game inputs provided by the player through an input device, such as a hand-held controller, are used to affect game state of the video game and to generate game play data 308 that is stored in the game play datastore 307. The game play data 308 is used to generate a game scenario capturing current game state of the video game. Frames of content of the game scenario are streamed to a client device of the player for rendering on a display screen associated with the client device. The game scenario rendered on the display screen includes game objects including static game objects and moving game objects (also referred to as “game assets”). Some of the game objects included in the game scenario may be provided to allow the player to gain points or to provide a challenge to the player. Some other game objects may be provided as part of the game scenario, while some of the remaining game objects may hold a tool or a clue or a key and require player interaction (i.e., action to achieve an interactive task) to enable the player to obtain the tool or unlock a challenge/level in order to progress in the video game. The game objects available in the game scenario dynamically change with changes in the game state of the video game. A haptic profiler 400 is configured to interact with the game logic of the game executing on the one or more game servers 302 to determine the game objects that are currently available in the game scenario of the game rendering on the display screen of the client device of the player, the game objects that hold clue or key or tool to progress in the video game, and the game objects the player has interacted with during game play. The haptics profiler 400, based on the interaction with the game logic, is able to correlate content of the current game scenario with context of actions performed by the player in the game scenario to identify a game object or interactive task that requires an action from the player. The game object or the interactive task that is identified has not yet been interacted with by the player during game play.

In response to detecting the game object or interactive task that requires the player's attention or action, a profile of the player playing the video game, is identified, as illustrated in operation 620. The profile of the player is stored in user datastore and includes play style of the player. As the player plays the video game and other video games more and more, the play style of the player is refined and the refined play style is updated to the player's profile.

The player's play style is used to generate a haptic response to the player, as illustrated in operation 630. A haptic learning engine 403 within the haptic profiler 400 is used to analyze the game play of the player to learn the player's game progression and to pick cues about the player's ability to understand the visual content provided in the game. The cues picked by the haptic profiler 400 are used to determine the play style of the player. The play style of the player, the current context of the game play content, and the personal progression made by the player in the game are used to determine the type of haptic response that is to be provided to the player. The haptic response identified for the player is specific to the player and is used to guide or direct the player toward the interactive task within the game scenario of the game rendering on the display screen of the client device. The haptic response identified for the player by the haptic learning engine 403 includes haptic setting that is dynamically applied to the input device (e.g., controller or other input device) as the user is playing the game.

The telemetry data generated from the game play of the player is processed to extract specific features that provide cues that are indicative of whether the player is progressing or not progressing in the game, whether the player is able to understand the visual content provided in the game or not, whether the player is able to cope with the speed or complexity of the game or not. The cues can be used, based on specific rules of the game, to determine if the player is a novice player or a good player or an excellent player, and whether the player needs assistance in the game play of the game. Such determination can be done by the amount of time taken by the player to progress through different portions of the game, number of attempts taken by the player to accomplish the task, etc. The haptic learning engine is able to progressively learn and interpret the different cues not only from the player's responses to game prompts but also from other players' responses. The haptic learning engine 403 aggregates the telemetry data of the plurality of players including the current player from different game play sessions, to fine tune the haptic settings that can be customized for the player or can be recommended for the player, based on their game play style. The haptic settings identified for the player can be used to adjust haptic responses or feedbacks provided to the player for any type of input device, like controller, head mounted display, wearable devices (e.g., smart glasses, smart watch, etc.), or any other peripheral devices that can be used for notifying the player. The customized notification can be extended beyond game application to any other interactive applications used by the player.

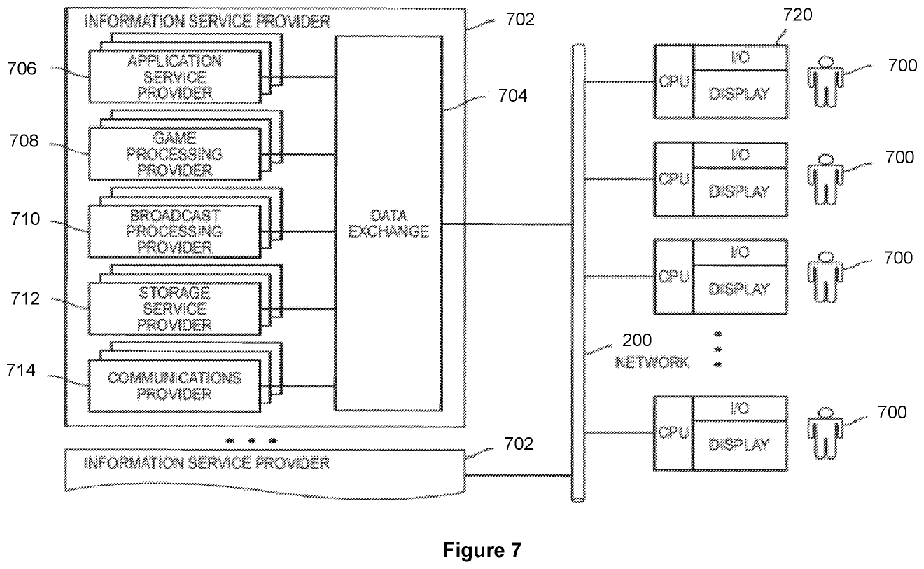

FIG. 7 illustrates an embodiment of an Information Service Provider architecture. Information Service Providers (ISP) 702 delivers a multitude of information services to users (i.e., players) 700 geographically dispersed and connected via network 200. An ISP can deliver just one type of service, such as stock price updates, or a variety of services such as broadcast media, news, sports, gaming, etc. Additionally, the services offered by each ISP are dynamic, that is, services can be added or taken away at any point in time. Thus, the ISP providing a particular type of service to a particular individual can change over time. For example, a user may be served by an ISP in near proximity to the user while the user is in her home town, and the user may be served by a different ISP when the user travels to a different city. The home-town ISP will transfer the required information and data to the new ISP, such that the user information “follows” the user to the new city making the data closer to the user and easier to access. In another embodiment, a master-server relationship may be established between a master ISP, which manages the information for the user, and a server ISP that interfaces directly with the user under control from the master ISP. In another embodiment, the data is transferred from one ISP to another ISP as the client moves around the world to make the ISP in better position to service the user be the one that delivers these services.

ISP 702 includes Application Service Provider (ASP) 706, which provides computer-based services to customers over a network (e.g. including by way of example without limitation, any wired or wireless network, LAN, WAN, WiFi, broadband, cable, fiber optic, satellite, cellular (e.g. 4G, 5G, etc.), the Internet, etc.). Software offered using an ASP model is also sometimes called on-demand software or software as a service (SaaS). A simple form of providing access to a particular application program (such as customer relationship management) is by using a standard protocol such as HTTP. The application software resides on the vendor's system and is accessed by users through a web browser using HTML, by special purpose client software provided by the vendor, or other remote interface such as a thin client.

Services delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common business applications online that are accessed from a web browser, while the software and data are stored on the servers. The term cloud is used as a metaphor for the Internet (e.g., using servers, storage and logic), based on how the Internet is depicted in computer network diagrams and is an abstraction for the complex infrastructure it conceals.

Further, ISP 702 includes a Game Processing Server (GPS) 708 which is used by game clients to play single and multiplayer video games. Most video games played over the Internet operate via a connection to a game server. Typically, games use a dedicated server application that collects data from players and distributes it to other players. This is more efficient and effective than a peer-to-peer arrangement, but it requires a separate server to host the server application. In another embodiment, the GPS establishes communication between the players and their respective game-playing devices exchange information without relying on the centralized GPS.

Dedicated GPSs are servers which run independently of the client. Such servers are usually run on dedicated hardware located in data centers, providing more bandwidth and dedicated processing power. Dedicated servers are the preferred method of hosting game servers for most PC-based multiplayer games. Massively multiplayer online games run on dedicated servers usually hosted by the software company that owns the game title, allowing them to control and update content.

Broadcast Processing Server (BPS) 710 distributes audio or video signals to an audience. Broadcasting to a very narrow range of audience is sometimes called narrowcasting. The final leg of broadcast distribution is how the signal gets to the listener or viewer, and it may come over the air as with a radio station or TV station to an antenna and receiver, or may come through cable TV or cable radio (or “wireless cable”) via the station or directly from a network. The Internet may also bring either radio or TV to the recipient, especially with multicasting allowing the signal and bandwidth to be shared. Historically, broadcasts have been delimited by a geographic region, such as national broadcasts or regional broadcast. However, with the proliferation of fast internet, broadcasts are not defined by geographies as the content can reach almost any country in the world.

Storage Service Provider (SSP) 712 provides computer storage space and related management services. SSPs also offer periodic backup and archiving. By offering storage as a service, users can order more storage as required. Another major advantage is that SSPs include backup services and users will not lose all their data if their computers' hard drives fail. Further, a plurality of SSPs can have total or partial copies of the user data, allowing users to access data in an efficient way independently of where the user is located or the device being used to access the data. For example, a user can access personal files in the home computer, as well as in a mobile phone while the user is on the move.

Communications Provider 714 provides connectivity to the users. One kind of Communications Provider is an Internet Service Provider (ISP) which offers access to the Internet. The ISP connects its customers using a data transmission technology appropriate for delivering Internet Protocol datagrams, such as dial-up, DSL, cable modem, fiber, wireless or dedicated high-speed interconnects. The Communications Provider can also provide messaging services, such as e-mail, instant messaging, and SMS texting. Another type of Communications Provider is the Network Service provider (NSP) which sells bandwidth or network access by providing direct backbone access to the Internet. Network service providers may consist of telecommunications companies, data carriers, wireless communications providers, Internet service providers, cable television operators offering high-speed Internet access, etc.

Data Exchange 704 interconnects the several modules inside ISP 702 and connects these modules to users 700 via network 200. Data Exchange 704 can cover a small area where all the modules of ISP 702 are in close proximity, or can cover a large geographic area when the different modules are geographically dispersed. For example, Data Exchange 704 can include a fast Gigabit Ethernet (or faster) within a cabinet of a data center, or an intercontinental virtual area network (VLAN).

Users 700 access the remote services with client device 720 (i.e., client device 100 in FIG. 1), which includes at least a CPU, a memory, a display and I/O. The client device can be a PC, a mobile phone, a netbook, tablet, gaming system, a PDA, etc. In one embodiment, ISP 702 recognizes the type of device used by the client and adjusts the communication method employed. In other cases, client devices use a standard communications method, such as html, to access ISP 702.

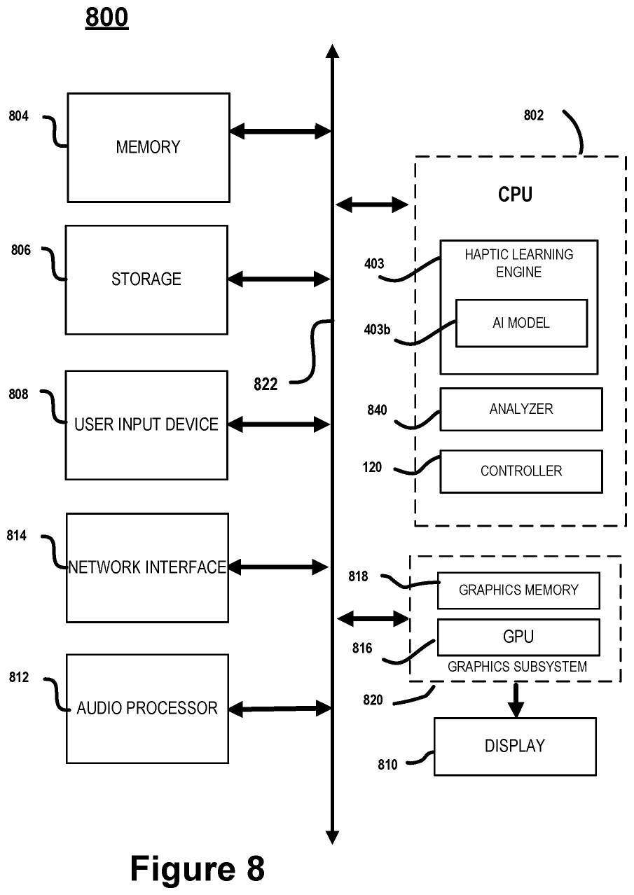

FIG. 8 illustrates components of an example device 800 that can be used to perform aspects of the various embodiments of the present disclosure. This block diagram illustrates a device 800 that can incorporate or can be a personal computer, video game console, personal digital assistant, a server 302 or other digital device, suitable for practicing an embodiment of the disclosure. FIG. 8 illustrates an exemplary device with hardware components suitable for training an AI model that is capable of performing various functionalities in relation to a video game and/or game plays of the video game, in accordance with one embodiment of the present disclosure. Device 800 includes a central processing unit (CPU) 802 for running software applications and optionally an operating system. CPU 802 may be comprised of one or more homogeneous or heterogeneous processing cores. For example, CPU 802 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, implementing and rendering the contextually relevant resources in a video game immediately, media and interactive entertainment applications, applications configured for deep learning, content classification, and user classifications. For example, CPU 802 may be configured to include the haptic learning engine 403, which is a machine learning algorithm (also referred to herein as AI engine or deep learning engine) that is configured to support and/or perform learning operations with regards to providing various functionalities (e.g., predicting, suggesting) in relation to a video game and/or game plays of the video game. Further, the CPU 802 includes an analyzer 840 that is configured for analyzing the inputs and interactions and providing the results of the analysis for generating and training the haptic learning model (AI model) 403b. The trained haptic learning model 403b provides an output in response to a particular set of players' inputs, wherein the output is dependent on the predefined functionality of the trained haptic learning model 403b. The trained haptic learning model 403b may be used to identify an optimal haptic setting output for dynamically applying to input device so that the input device can provide an appropriate notification to the player, during game play. The notification may be to guide the player toward a interactive task or provide feedback in regards to a move or action the player has to make or is making in the game.

Device 800 may be localized to a player playing a game segment (e.g., game console), or remote from the player (e.g., back-end server processor), or one of many servers using virtualization in a game cloud system for remote streaming of gameplay to client devices (or simply referred to as “clients”).

Memory 804 stores applications and data for use by the CPU 802. Storage 806 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 808 communicate user inputs from one or more users to device 800, examples of which may include keyboards, mice, joysticks, touch pads, touch screens, hand-held controllers, wearable controllers, still or video recorders/cameras, tracking devices for recognizing gestures, and/or microphones. Network interface 814 allows device 800 to communicate with other computer systems via an electronic communications network, and may include wired or wireless communication over local area networks and wide area networks such as the internet. An audio processor 812 is adapted to generate analog or digital audio output from instructions and/or data provided by the CPU 802, memory 804, and/or storage 806. The components of device 800, including CPU 802, memory 804, data storage 806, user input devices 808, network interface 814, and audio processor 812 are connected via one or more data buses 822.

A graphics subsystem 820 is further connected with data bus 822 and the components of the device 800. The graphics subsystem 820 includes a graphics processing unit (GPU) 816 and graphics memory 818. Graphics memory 818 includes a display memory (e.g., a frame buffer) used for storing pixel data for each pixel of an output image. Graphics memory 818 can be integrated in the same device as GPU 816, connected as a separate device with GPU 816, and/or implemented within memory 804. Pixel data can be provided to graphics memory 818 directly from the CPU 802. Alternatively, CPU 802 provides the GPU 816 with data and/or instructions defining the desired output images, from which the GPU 816 generates the pixel data of one or more output images. The data and/or instructions defining the desired output images can be stored in memory 804 and/or graphics memory 818. In an embodiment, the GPU 816 includes 3D rendering capabilities for generating pixel data for output images from instructions and data defining the geometry, lighting, shading, texturing, motion, and/or camera parameters for a scene. The GPU 816 can further include one or more programmable execution units capable of executing shader programs.

The graphics subsystem 820 periodically outputs pixel data for an image from graphics memory 818 to be displayed on display device 810. Display device 810 can be any device capable of displaying visual information in response to a signal from the device 800, including CRT, LCD, plasma, and OLED displays. Device 800 can provide the display device 810 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure of the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server 302 may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of PEs, each of which may reside on different server units of a data center.

According to this embodiment, the respective PEs for performing the may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a PE associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, a mobile device, etc. In one embodiment, the network executing on the game server recognizes the type of client device used by a user and adjusts the communication method employed. In other cases, client devices use a standard communications method, such as html, to access the application on the game server over the internet.

It should be appreciated that a given video game or gaming application may be developed for a specific platform and a specific associated controller device (or simply referred to as “controller”) 120. However, when such a game is made available via a game cloud system as presented herein, the user (e.g., player) may be accessing the video game with a different controller 120. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller 120 (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller 120 are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g. prior to beginning gameplay of the video game, so as to acclimate the user to the operation of the controls on the touchscreen.

In some embodiments, the client device serves as the connection point for a controller 120. That is, the controller 120 communicates via a wireless or wired connection with the client device to transmit inputs from the controller 120 to the client device. The client device may in turn process these inputs and then transmit input data to the game cloud server via a network (e.g. accessed via a local networking device such as a router). However, in other embodiments, the controller can itself be a networked device, with the ability to communicate inputs directly via the network to the game cloud server, without being required to communicate such inputs through the client device first. For example, the controller might connect to a local networking device (such as the aforementioned router) to send to and receive data from the game cloud server. Thus, while the client device may still be required to receive video output from the cloud-based video game and render it on a local display, input latency can be reduced by allowing the controller to send inputs directly over the network to the game cloud server, bypassing the client device.

In one embodiment, a networked controller and client device can be configured to send certain types of inputs directly from the controller to the game cloud server, and other types of inputs via the client device. For example, inputs whose detection does not depend on any additional hardware or processing apart from the controller itself can be sent directly from the controller to the game cloud server via the network, bypassing the client device. Such inputs may include button inputs, joystick inputs, embedded motion detection inputs (e.g. accelerometer, magnetometer, gyroscope), etc. However, inputs that utilize additional hardware or require processing by the client device can be sent by the client device to the game cloud server. These might include captured video or audio from the game environment that may be processed by the client device before sending to the game cloud server. Additionally, inputs from motion detection hardware of the controller might be processed by the client device in conjunction with captured video to detect the position and motion of the controller, which would subsequently be communicated by the client device to the game cloud server. It should be appreciated that the controller 120 in accordance with various embodiments may also receive data (e.g. feedback data) from the client device or directly from the game cloud server.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for providing a haptic response to a user during game play of a video game, comprising:
detecting an interactive task within a game scenario of the video game that requires an action from the user, the interactive task identified by correlating content of the game scenario with context of actions performed by the user in the game scenario;
identifying a user profile of the user playing the video game; and
generating the haptic response to the user in accordance to haptic settings defined for the user profile of the user, the haptic response provided to the user via a controller used for providing game input to the video game, the haptic response is specific for the user and is used to guide the user toward the interactive task within the game scenario of the video game.

2. The method of claim 1, wherein the haptic response continues till the action from the user is detected at the interactive task.

3. The method of claim 1, wherein the haptic response includes deactivating controls of the controller so as to prevent the user from progressing in the video game till the action from the user is detected at the interactive task.

4. The method of claim 1, wherein the haptic response is generated using features of the controller.

5. The method of claim 1, wherein the haptic response includes a spatial cue for directing the user toward the interactive task in the game scenario, wherein the spatial cue is provided using a three-dimensional representation of the game scenario of the video game.

6. The method of claim 1, wherein the haptic response is triggered in accordance to the haptic settings that are customized for the user.

7. The method of claim 6, wherein the haptic settings are defined based on input provided by the user.

8. The method of claim 6, wherein the haptic settings are dynamically defined based on a play style of the user, the play style determined using a haptic learning engine that uses machine learning logic, the haptic learning engine dynamically trained with game inputs of the user and game progression made by the user in the video game, the haptic settings dynamically adjusted from the training of the haptic learning engine and applied to the controller, when the haptic response is triggered, and wherein adjustment to the haptic settings are updated to the user profile of the user.

9. The method of claim 8, wherein the game progression is determined using telemetry data collected from the game play of the video game of the user, wherein the telemetry data is analyzed to extract specific features that are indicative of the play style of the user or the game progression of the video game.

10. The method of claim 1, wherein the action required from the user is a movement in a particular direction, and the haptic response provided during game play includes a directional cue to indicate a direction the user needs to move or a direction where the interactive task is located in the game scenario.

11. The method of claim 10, wherein the controller has a plurality of haptic elements, and the directional cue provided in the haptic response includes activating haptic settings of the plurality of haptic elements sequentially so as to allow the haptic response to flow from one haptic element to a subsequent haptic element of the plurality of haptic elements in the direction specified in the directional cue.

12. The method of claim 1, wherein the haptic response is defined to provide variation in a feedback provided to the user, wherein the variation in the feedback is dynamically controlled based on the action performed by the user in the video game and is intuitive to the user.

13. The method of claim 1, wherein the haptic response is configured to vary with time, based on content of game scenario of the video game or game input provided by the user.

14. The method of claim 1, wherein the haptic response for the user is generated to correlate with content of the game scenario and context of actions performed by the user in the game scenario.

15. The method of claim 1, wherein the interactive task is an action performed by the user to interact with a game asset or an avatar of another user playing the video game.

16. A method for providing a haptic response to a user during game play of a video game executing on a server of a game cloud system, comprising:
identifying an interactive task within a game scenario of the video game that requires an action from the user, the interactive task identified by correlating content of the game scenario with context of actions performed by the user in the game scenario;
identifying a user profile of the user playing the video game; and
generating the haptic response to the user in accordance to haptic setting defined for the user profile of the user, the haptic response is specific for the user and is used to guide the user toward the interactive task within the game scenario of the video game.

17. The method of claim 16, wherein the haptic response is provided to the user via a game controller used for providing game input to the video game.

18. The method of claim 17, wherein the haptic response is generated using features of the game controller.

19. The method of claim 17, wherein the haptic response includes deactivating controls of the game controller so as to prevent the user from progressing in the video game till the action from the user is detected at the interactive task.

20. The method of claim 16, wherein the haptic response is provided to the user via a head mounted display used for viewing game play of the video game.

21. The method of claim 16, wherein the haptic response includes a spatial cue for directing the user toward the interactive task in the game scenario, wherein the spatial cue is provided using coordinates of the interactive task within a three-dimensional representation of the game scenario of the video game.

22. The method of claim 16, wherein the haptic response is triggered in accordance to haptic settings that are customized for the user.

23. The method of claim 22, wherein the haptic settings are pre-defined by the user.

24. The method of claim 22, wherein the haptic settings are dynamically defined based on a play style of the user.

25. The method of claim 16, wherein the haptic response continues till the action from the user is detected at the interactive task.

26. A method for providing a haptic response to a user during game play of a video game executing on a server of a game cloud system, comprising:
examining game actions performed by the user during game play of the video game, context of the game actions examined in relation to content of a game scenario occurring in the video game;
identifying information related to the haptic response that is to be provided to the user, based on the examination of the game actions, the information used to define haptic settings that is specific for the user, the defined haptic settings being stored in a user profile of the user, the information related to the haptic response being dynamically updated based on the game actions of the user collected during game play, the updates to the information cause a corresponding update to the haptic settings defined in the user profile of the user; and
generating the haptic response to the user in response to detecting an interactive task within the game scenario of the video game that requires a game action from the user, the interactive task identified by correlating content of the game scenario with context of game actions performed by the user in the game scenario,
wherein the haptic response is generated in accordance to the haptic settings defined in the user profile of the user and is generated to guide the user toward the interactive task within the game scenario of the video game.

27. The method of claim 26, wherein the haptic response is provided to the user via a controller used for providing game input to the video game, and
wherein the haptic response is provided using features of the controller.

28. The method of claim 26, wherein the haptic response is provided to the user via a head mounted display used for viewing game play of the video game, the haptic response is provided using features of the head mounted display.

29. The method of claim 26, wherein the haptic response is provided to notify the user of a certain behavior required of the user during the game play to accomplish a goal of the interactive task.

30. The method of claim 26, wherein the haptic settings of the user are defined based on a play style of the user identified from examining the gaming actions.
